(19) United States
(12) Patent Application Publication
(10) Pub. No.: US 2008/0264063 A1
(43) Pub. Date: Oct. 30, 2008

(54) Planetary improvement motor

(75) Inventor: Diego Linares, Tucson, AZ (US)

Correspondence Address: Diego Linares, 4614 E. Calle Corta, Tucson, AZ, 85712, US

(73) Assignee: Diego, Tucson, AZ (US)

(21) Appl. No.: 11/789,588

(22) Filed: Apr. 25, 2007

(51) Int. Cl. F03G 7/04; F03B 17/04

(52) U.S. Cl. 60/721; 415/916

(57) ABSTRACT

The Planetary Improvement Motor uses new thermodynamic ideas that redefine heat pumps and engines with an immaculate engine and pump design that can replace nearly all engines and pumps with one basic, simple design. The Planetary Improvement Motor can save the planet if you let it.

WOW! YOU MUST BE LIKE A PHYSICIST OR SOMETHING TO COME UP WITH SUCH A GREAT IDEA? Actually, “No, I have never been interested in medicine. I am an artist, this is my art.”

Unlimited pollution free energy. A hyper-efficient positive displacement heat engine and heat pump constructed from as few as two components, one moving assembly, one stationary assembly, with absolutely no physical contact between the two assemblies. The lack of contact parts and the cleanliness of a closed-loop environment result in a nearly unlimited potential life expectancy. It can be configured for both open-loop and closed-loop operation. Hyper-efficient heat conversion is made possible through a new form of positive displacement called constant volume displacement, and a new thermodynamic cycle that can operate on temperature differentials considerably less than one degree. This new thermodynamic cycle can be daisy chained infinitely in both open and closed loop and can be directly integrated into most existing heat engine systems with few or no modifications to the existing systems and without having to take the existing systems offline. This new thermodynamic cycle is called the Super Duper Super Uper Duper Cycle “SDSUDC”.

### CROSS REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER DISC

Not Applicable

### BACKGROUND OF THE INVENTION

The first paragraph contains a few conventions for this patent application. First I designed and built some motors. Then I learned the gibberish to explain why the motors function, for this patent application. A result some concepts may be expressed in a different manner than a person with very specific knowledge in the field might express them. However, the concepts are none the less very clearly and accurately explained and defined in a manner that is unambiguous, repeatable and verifiable. In order to ensure that there is no ambiguity I have included a vast number of drawings representing both mechanical and abstract concepts as well as in-depth explanations. A range of PIMs are represented. Terms in bold are claims and or details of claims. Engine, pump, heat pump, compressor, generator are used interchangeably since they are all forms of heat to work converters and PIMs can perform all of these functions. PIMs can transfer work mechanically or electrically. Most PIMs can reverse in function, and can be equally efficient for both forward function and reverse function.

The Planetary Improvement Motor pertains primarily to thermodynamics, fluid dynamics, and electrodynamics as they affect engines, pumps and generators. It has always been a primary goal of physics to find more efficient methods of converting heat to useable work. Ideally we would be able to convert heat to work at 100% conversion and waste nothing.

Existing positive displacement engines have a nearly endless amount of inherent design flaws which cannot be engineered out. Displacement engines convert heat to work by using mechanical components to contain a fluid, then leveraging the expansion of that fluid against the mechanical components for a limited duration. Energy losses and wear due to mechanical friction between components is unavoidable due to mechanical contact dictated by present designs. More importantly the bigger losses actually occur from the inefficiency of the fuel burn and the inability to convert much of the heat energy into work during one displacement. Hot radiators, and hot exhaust gasses are nothing more than clear evidence of wasted energy. If a positive displacement engine could convert 100% of the energy, the radiator and the exhaust gasses would be ambient temperature.

Existing turbine engines are certainly much more efficient, longer lasting, and more reliable than displacement engines. This is due primarily to the lack of mechanical contact among components and the much more efficient fuel burn. However turbines are also inherently flawed in ways that cannot be engineered out. The biggest problem with turbines is also the primary reason for their efficiency. Turbines essentially leverage the movement created by the expansion of fluid directly against a stationary lower pressure fluid to turn a series of fans. While this increases efficiency greatly by eliminating mechanical friction among components the inherent problem is that fluid is exactly that, fluid. Therefore in order to generate useable work without mechanical containment, the fluid must be expanded and utilized in an extremely short duration. This requires a very high temperature and fluid flow. The result is that turbines are expensive to manufacture and highly impractical for many applications.

The Carnot heat cycle is considered to be the most efficient possible conversion of heat to work. It is one of six unique cyclic process engines that define the functions of pretty much all other cyclic process engines. There has been no new truly unique cyclic process discovered in over a century. This is the core problem of why the most efficient conversion method is only somewhere around 70% in the most efficient super expensive utility plant turbines. Everybody seems to have made the assumption that there are no new cyclic processes left to be discovered, and that the only way to increase efficiency is by improving the same processes. These processes have only been able to achieve 70% conversion after 200 years of engine R&D. Unimpressive! In fact really, really, really unimpressive! I didn't realize this when I started designing and building the Planetary Improvement Motor and now it's too late because I accidentally designed the PIM a positive displacement pump and engine (a pimgine) with a new unique modular, reversible at equal efficiency, daisy chainable, cyclic process that can be open loop or closed loop Super Duper Uper Duper Cycle. I believe that SDSUDC has a 99+% heat to work conversion potential. I also believe that it operates at the exact same efficiency for both forward function and reverse function. Oops!

### BRIEF SUMMARY OF THE INVENTION

This invention, the Planetary Improvement Motor (PIM) is a pump and engine, designed to stop the increasing the greenhouse effect and end world hunger by converting energy at previously impossible efficiency levels. The PIM can function as a vacuum pump, pressure pump, heat pump, heat engine, generator etc, and it can be reversed for all functions.

The PIM can perform all functions much more efficiently than any other existing design. The PIM is also simpler, smaller, longer lasting and cheaper to produce than any other design. Quite simply the PIM can and will replace every existing non electric pump and engine design on the planet.

The PIM can be used as an open loop engine or pump, or as a closed loop engine or pump. It is usually reversible at equal efficiency for all functions. Whether constructed as a closed loop or open loop it is capable of extreme efficiency.

The PIM designed to be extremely simple to manufacture. It can be made from any material that remains stable enough within the desired operating temperature range of the PIM. It can be configured for any temperature range making it ideal for high heat/power (turbine replacement), as well as low heat/power (solar electric and portable battery replacement).

In the most basic sense a PIM converts heat to work by altering the energy level of fluid within a fixed volume chamber, in order to displace fluid. The equalization of pressure on both entry and exit of fluid to and from the chamber(s) is the mechanism that converts the heat to work or the work to heat. A PIM can do this by equalizing fluid pressure between stationary and moving chambers. A PIM can daisy chain stationary and moving chambers infinitely. This method of fluid displacement is called Constant Volume Displacement “CVD”.

Mechanically a PIM can best be described as a cross between a multistage turbine and a multistage piston engine with the best attributes of both and none of the negatives. The PIM is a true cyclic positive displacement pump and engine (pimgine), fitting every criterion that defines a positive displacement pump and positive displacement engine. However it can do this with ABSOLUTELY NO CONTACT BETWEEN THE STATIONARY AND MOVING COMPONENTS!

Thermodynamically a PIM it can best be described as a cyclic process engine that can have from two to infinity thermodynamic loops contained within the same system. It is based on a new cyclic process I have named the Super Duper Super Uper Duper Cycle “SDSUDC”. This cyclic process differs greatly from all other cyclic process in that it is modular, can be daisy chained, and can usually be inserted anywhere in the thermodynamic loop of any other thermodynamic process. SDSUDC can also be configured for both open-loop and closed-loop operation. When SDSUDC is represented on a PV diagram SDSUDC does not look like the typical PV loop for a cyclic process engine. A blob composed four subsystems (AB, BC, CD, & DA) of varying size and shape. SDSUDC always has ninety degree corners and perfectly flat sides. At first glance the SDSUDC PV loop appears as an infinitely thin vertical line with uniform length, horizontally protruding lines at regular intervals. The fact is that each of the horizontally protruding lines is actually three subsystems of a PV loop and the vertical line connecting the two horizontal lines is actually the fourth subsystem of the PV loop. From a time perspective SDSUDC might actually be described as having the potential of being perfectly asymmetric. SDSUDC is able to devote as much as 100% of the thermodynamic cycle time along only one of the four subsystems within the PV loop (the one that is working) and as little as 0% of the time to the three other subsystems within the same loop. SDSUDC is also special because the loop can be made infinitely small by daisy chaining an infinite number of SDSUDC cycles within the same system. I believe that the ability to infinitely daisy thermodynamic loops within the same system therefore allowing a difference in pressure ΔP to be divided infinitely ΔP/∞ and therefore a difference in energy ΔE to be divided infinitely ΔE/∞ is what allows 99+% conversion. The ability to divide a difference in pressure infinitely allows SDSUDC to infinitely divide the thermodynamic loop size resulting in a potential for a change in energy as small as one. SHAZAM!

Value locking allows a PIM to produce power/pressure up to 100% of the time it is in operation. Typical four stroke piston engines produce power/pressure less than 25% of time. A turbine works 100% but requires a large temperature differential to operate. Value locking causes forced simultaneous subsystem pairing “FSSP” to occur. FSSP forces the isothermal and isometric thermodynamic cycles to occur nearly simultaneously by not allowing their relationship to vary. This results in the shortest possible time component for the flow within each thermodynamic subsystem pair. If the time component is removed from the non working portions of the thermodynamic cycle and shifted to the working portions the total system entropy for that cycle is greatly reduced. The other result of value locking is forced loop pairing. Forced loop pairing is when thermodynamic PV loops are forced to exist only as pairs of thermodynamic PV loops and cannot exist as individual thermodynamic PV loops.

The ideal embodiment of a PIM is closed loop and has only two parts. One moving assembly, one fixed assembly, and no contact between the two assemblies. It has both permanent magnetic bearings and fluid pressure bearings requiring no physical contact between assemblies, and it is constructed from borosilicate glass or any material that has extreme thermal stability. A PIM can have a nearly unlimited life expectancy if properly constructed.

### BRIEF DESCRIPTION OF SEVERAL VIEWS OF THE DRAWINGS

It is less confusing to read the application in its entirety BEFORE attempting to understand the drawings. The drawings are broken down into six groups. Five groups correspond to five different engines demonstrating various aspects of Planetary Improvement Motors. There is also a sixth group of general drawings which are used to demonstrate principles that apply to all Planetary Improvement Motors.

Five different Planetary Improvement Motors are drawn. Each Planetary Improvement Motor has a corresponding set of worksheets that explain certain aspects of the drawings. The worksheets and drawings provide some general ways to compare all of the different PIMs to each other as well as insight as to how group timing system works. The perspectives of the drawings that accompany the motors are also similar to each other for a basis for comparison. Following this paragraph will be the LEGEND (paragraphs [028]-[045]) which includes the worksheet decodes and part number decodes, followed by one paragraph explaining each of the four drawing perspectives that are common to all five Planetary Improvement Motors shown, as well as one paragraph explaining each of the five Planetary Improvement Motors. This will be followed by the individual description by figure number.

Planetary Improvement Motor Worksheet Decode

| | |
|---|---|
| Model Name | Name |
| Design Use | Designed use |
| Possible Uses | Likely alternative uses |
| Manufacturing Equipment | Equipment required to manufacture |
| Manufacturing Method | A basic overview of the procedures |
| | required to manufacture |
| Materials | Most likely materials used to |
| | manufacture |
| Displacement Style | Method of arranging chambers and |
| | direction of fluid flow |
| Differential Seeding | Method used to displace non- |
| | compressible fluid |
| Open Loop or Closed Loop | Indicates whether the transfer |
| | fluid operates in an open loop |
| | or closed loop |
| Recirculation Method | Method that is used to close the |
| | loop affecting the transfer fluid |
| Transfer Fluid | Primary fluid used to transfer |
| | energy between stationary and |
| | moving components |
| Bearing Style | Primary method used to maintain |
| | the correct clearance between |
| | stationary and moving components |
| Differential Method | Method and source for transferring |
| | heat into or out from a pump or |
| | engine |
| Expansion Contraction | Indicates whether fluid is expanded |
| | or contracted in order to convert |
| | heat to work |
| Power Method | Method for transferring work into |
| | or out from a pump or engine |
| Seal Style | Method and material used to seal |
| | valves |
| Mass Displacement Ratio | Method and mass displacement |
| | difference between the lowest |
| | pressure stage and the highest |
| | pressure stage |
| Plane Orientation | Indicates the relative orientation |
| | of the four physical planes to |
| | which group timing system is being |
| | applied |
| Total CVD Discs | Indicates total number of CVD discs |
| Moving CVD Discs | Indicates total number of CVD discs |
| | that are moving |
| Stationary CVD Discs | Indicates total number of CVD discs |
| | that are stationary |
| Stages | Indicates total number of different |
| | pressure zones affecting this pump |
| | or engine |
| RPM Range | Intended operational range and |
| | maximum RPM |
| Displacements per | Total number of displacements that |
| Revolution or Linearlution | occur in one revolution or |
| | linearlution |
| Maximum Displacements per | Total number of displacements that |
| Minute | occur during a one minute duration |
| | operating at maximum rpm |
| General discussion | A general discussion of the pump |
| | or engine |

Group Timing System Worksheet Decode

Items are given in terms relative to displacement duration because displacement duration is the duration of one displacement.

| | | |
|---|---|---|
| X = Group Duration | X/Y = A | |
| Y = Number of displacements in group | Y · A = X | |
| A = Displacement Duration | A | |
| B = Valve Opening Duration Range | B ≦ .5A | |
| C = Total Pause Duration | C + B = A | C = A − B |
| D = Exhaust duration range | D + C + F = A | D = .5B |
| Dₐ = Exhaust valve opening duration | Dₐ ≦ D | |
| F = Intake duration range | F + C + D = A | F = .5B |
| Fₐ = Intake valve opening duration | Fₐ ≦ F | |
| E = Pause one | E + B + G = A | E ≧ .5B |
| G = Pause two | G + B + E = A | G ≧ .5B |

### Item Number Decode

First position indicates what the item actually is. The first position is represented by a two digit number. 01-25=Concrete object. 26-50=Abstract object.

Second position indicates whether the item is moving or stationary. The second position is represented by an M for moving and or an S for stationary.

Third position indicates the item location based on pressure, and is represented by a ratio composed of whole numbers whole number/whole number. The first number indicates the actual pressure zone that the item associated with. The second number is the total number of pressure zones that are associated with the pump or engine while in operation. The number one always represents the lowest pressure zone. pressure zone associated with item/total number of pressure zones associated with pump or engine

### ITEM DECODE EXAMPLES

### Example 1

Part number 01 MS2/4
01=Bearing.
MS=Item has both moving and stationary components.
2/4=Item is associated with the second lowest pressure zone of four pressure zones affecting this pump or engine.

### Example 2

Part number 09S1/7
09=CVD transfer cap.
S=Item is stationary.
1/7=Item is associated with the lowest pressure zone of a total seven pressure zones affecting this pump or engine.

### 1-25 CONCRETE OBJECTS

1. Bearing
2. CVD Core coupler
3. CVD Disc
4. CVD Disc Core
5. CVD Disc Housing
6. CVD Exhaust Valve
7. CVD Housing Coupler
8. CVD Intake Valve
9. CVD Transfer Cap
10. DDC Chamber Complete
11. DDC End Wall
12. DDC Exhaust Valve Port
13. DDC Intake Valve Port
14. DDC Sidewall
15. Flow Limiter
16. Generator Bearing Magnet
17. Onboard Energy Storage Tank
18. Transfer Bars
19.
20.
21.
22.
23.
24.
25.

### 25-50 ABSTRACT OBJECTS

26. CVD Disc O.D.
27. CVD Disc I.D.
28. Group Duration
29. Group Offset
30. Displacement Duration
31. Displacement Duration Offset
32. Electrical Insulator
33. Electrical Conductor
34. Exhaust Duration Range
35. Exhaust Valve Opening Duration
36. Heat/Pressure added
37. Heat/Pressure subtracted
38. Intake Duration Range
39. Intake Valve Opening Duration
40. Pause Two Duration
41. Pause One Duration
42. Thermal Insulator
43. Thermal Conductor
44.
45.
46.
47.
48.
49.
50.

Five motors have drawings based on the same or similar perspective that are labeled at the top of each drawing. Circular 44441111 also has a set of additional drawings that the other pumps or engines don't. This is done simply because Circular 44441111 is the first PIM that is explained. The best way to compare the various pumps or engines to each other is to lay out all the matching drawings and worksheets on a table in a grid. This works very nicely since they all share the same basic set of drawings and worksheets.

First drawing labeled three dimensional is a three dimensional view of the entire pump or engine and its internal components. Engine primary components are separated from each other and motor is partially disassembled. View is an approximate downward forty five degree perspective.

Second drawing is labeled cross section. This is a two dimensional view of the pump or engine as if it where split exactly in the middle and you are viewing the cross section of one of the halves. This is a great view for demonstrating how much easier it is for the fluid to add or subtract energy to the moving components than it is for the fluid to leak. The passage through the chambers is large and free flowing however in the drawings you can see that the passage where fluid can leak is very long and constricted. It is easy to see why leakage is not an issue when the size and length of the leakage passage is compared to the size and length of the passage through the discs. This is also a great view for demonstrating the lack of contact between stationary and moving components.

Third drawing labeled Group Timing System view is not a concrete view; it is an abstract view that shows the time relationships that are necessary for constant volume displacement and that are governed by group timing system. The abstract perspective shows the four different equal duration time planes that govern the functions occurring along four corresponding physical planes. This drawing is intended to be a visually simple way of comparing the time relationships of various Planetary Improvement Motors to each other.

Fourth drawing Abstract Cutaway and PV Loop is the best drawing for understanding how a Planetary Improvement Motor actually works. Abstract Cutaway and PV Loop is not a concrete view of physical components it simply resembles a cutaway of an actual PIM. Abstract Cutaway and PV Loop is a further use of an abstract time perspective view with the addition of arrows to indicate fluid movement and Xs to indicate fluid stop. This is a great perspective to understand how the various durations affect the flow of fluid. This view is depicted over the duration of one single fluid displacement in the system. This perspective also incorporates a PV diagram in order to tie together the flow of fluid with the thermodynamic loop.

First Planetary Improvement Motor labeled Circular 44441111 is simply a demonstrator that introduces constant volume displacement in a circular fashion. Circular Planetary Improvement Motors have the highest efficiency potential of all PIMs because they can be easily packaged in a closed loop environment and they are most easily adapted to the largest range of uses. Circular 44441111 only has one chamber and one stage and is therefore highly inefficient; however it is much easier to understand the basics before going on to a more complex design. The Circular 44441111 has only one spinning disc that rotates on a shaft that is mounted on roller bearings that are in turn mounted on two fixed discs. No contact parts except for the bearings.

Second Planetary Improvement Motor labeled Lateral 44441111 is a simple technology demonstrator that shows constant volume displacement being applied to an open loop motor that provides linear motion. It utilizes the same valve timing durations as the first model and the same style chambers and fluid movement however the chambers are laid out in a linear fashion. Think of comparing a circular Planetary Improvement Motor to a lateral Planetary Improvement Motor like comparing a standard rotating electric motor to a linear electric motor. It's the exact same motor only in a straight line. It is called a lateral PIM because although the motor motion is linear the fluid is displaced perpendicular to motor movement, in other words laterally relative to engine movement hence the name Lateral 44441111.

Third Planetary Improvement Motor labeled Linear 484121 is a simple technology demonstrator that shows constant volume displacement being applied to an open loop motor that provides linear motion just like 44441111 Lateral. Linear 484121 uses the same valve timings as the first two PIMs except that in Linear 484121 the fluid movement is not perpendicular to, but is in fact parallel to motor movement along the same axis of motion except that fluid is displaced in the opposite direction of motor movement. The same valve timing applies however because of the arrangement the chambers it looks considerably different. The moving chambers are double length and the stationary chambers on the barrel walls are single length with only one valve that functions as both an intake and exhaust. This style has great potential for extremely high speed and large bore barrel and projectile applications. The main limiting factors for bore size and projectile velocity in cannons are mostly related to breach pressures and are typically dealt with by having powders that burn at very specific rates in order to control the breach pressure, and by making cannons from very high strength steels. A linear PIM can operate with ZERO breach pressure and because of this is not limited in speed by breach pressure but instead the limits are related to air friction, although it is the heat from the friction that helps to increase the velocity potential by superheating the fluid to increase pressure. This type of motor might have the potential to launch locomotive size chunks of frozen concentrated greenhouse gasses encased in a shell, at orbital velocity, directly from the ground.

Fourth Planetary Improvement Motor labeled Turbine Replacement 66661111 is a bit more complex and shows constant volume displacement being applied to an open loop circular PIM. 66661111 is much closer to what an actual functional model will look like, because of the many stages and chambers. Turbine Replacement 66661111 generates 250,000 fluid displacements per second at 30,000 rpm. This model is designed to be internal combustion in order to provide the greatest power density and should be able to provide higher power to weight ratios than turbines at higher efficiencies. In this model the chambers are smaller on fluid entry and larger on fluid exit in order to be able to provide the greatest expansion potential in the smallest motor package. Turbine Replacement 66661111 transfers work into and out from itself with a rotating shaft and electricity. The magnets can be used to turn the motor and start the combustion process or turbine replacement can simply be used as an electrically powered super efficient compressor. The timing is different than the previous three PIMs in that more time has been provided for heat transfer inside of the chambers, as well as a larger fluid reservoir inside of the chambers. This model is also representative of what air compressors will look like as well as water and wind turbine replacement PIMs will be like. This style will provide the greatest power density in the short term however as PIM technology progresses, closed loop motors containing a phase changing fluid will provide comparable power densities to open loop motors at higher efficiencies with little or no maintenance and superior longevity.

Fifth Planetary Improvement Motor labeled Perfect Pump 55551111 is intended to demonstrate what the perfect embodiment for PIMs will be. Perfect Pump is a closed loop Planetary Improvement Motor that contains a high power density phase change fluid such as liquid nitrogen or liquid helium. Here is where the multiplicity of stages and chambers really start to add up and the numbers get crazy. Perfect Pump 55551111 has ten moving discs with twenty chambers each resulting in four thousand individual displacements per revolution. At sixty thousand revolutions per minute Perfect Pump 55551111 is generating four million displacements and eight million thermodynamic loops in ONE SECOND. Creating a total of four hundred and eighty million (480,000,000) thermodynamic loops per minute with a total duration per loop of 0.0000012 seconds. In a package that could be made to fit in a phone or portable computer and that could be powered by body heat or sunlight. Or it could be made as large as needed. Perfect Pump 55551111 transfers work into and out of the motor electrically only. Perfect Pump 55551111 can be configured either as a heat powered electric generator or as an electric powered heat pump with absolutely no difference in components, it is a true pimgine. When reversing function the only thing altered is the direction of the timing, it simply has to be flipped in order to point the asymmetry in the direction necessary for the desired function. Perfect Pump 55551111 is made from borosilicate glass because of its extreme rigidity, thermal stability, and it's near imperviousness to decay or chemical corrosion. Perfect Pump 55551111 has absolutely no contact parts. The moving assembly is separated from the fixed assembly through the use of neodymium magnets embedded in both assemblies. These magnets not only provide a bearing but also generate an electrical field in order to add work to, or subtract work from the moving assembly. The electricity is transferred in and out from Perfect Pump 55551111 with copper bars or wires that are embedded in the glass and therefore protected from corrosion. Gold plated connectors are used where the connections meet the environment in order to reduce electrolysis at the connection. Perfect Pump 55551111 has only two permanently enmeshed parts when completed. The moving assembly and the stationary assembly, each of which is composed many glass components fused together. Perfect Pump 55551111 is extremely cheap to produce requiring only glass, magnets, and copper, and minor gold plating. Perfect Pump is completely recyclable [symbol] ).

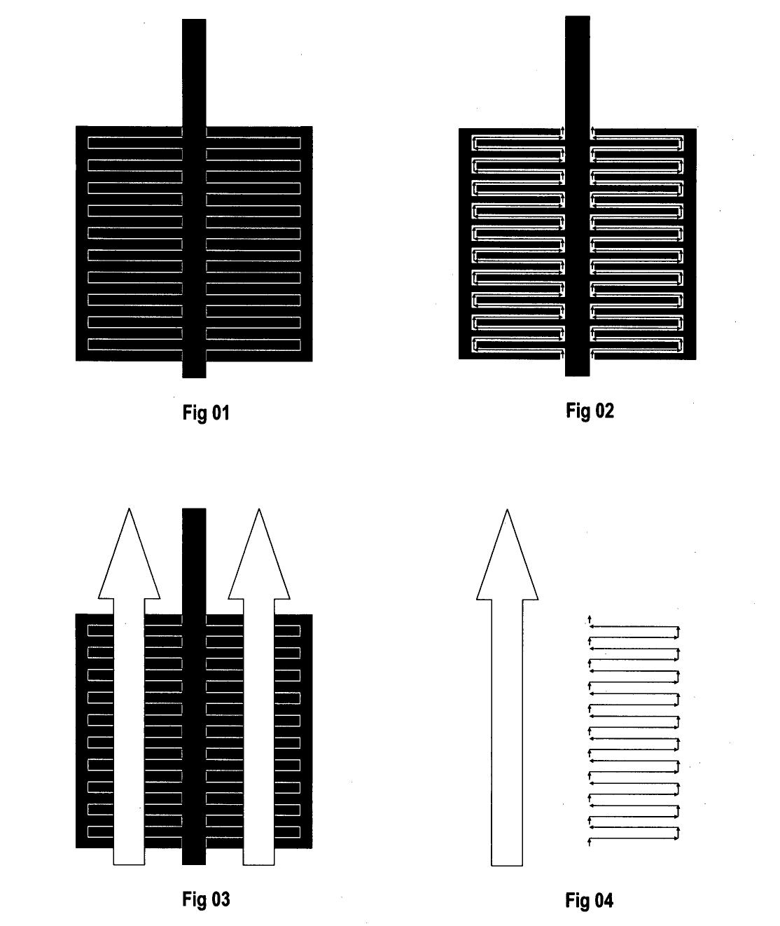

FIG. 01 Fluid path for fluid leakage around chambers

FIG. 02 Fluid path for fluid leakage around chambers emphasized with lines and arrows

FIG. 03 Fluid path for fluid imparting energy to rotating assembly

FIG. 04 Comparison of both length and size of the fluid leakage path and the fluid working path

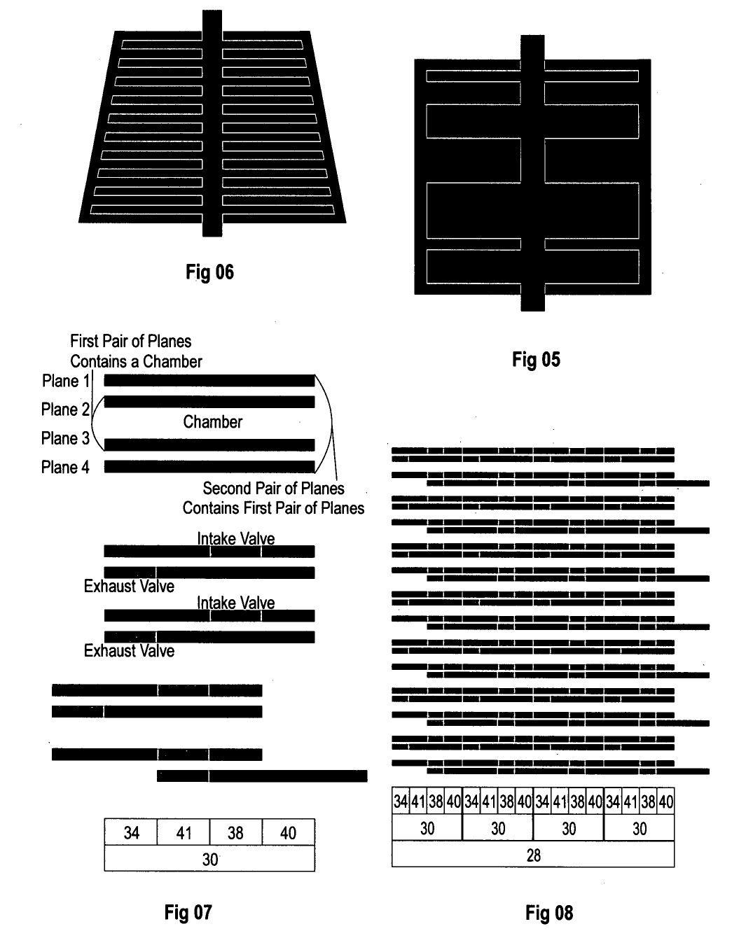

FIG. 05 Displays ratio method called disk stacking

FIG. 06 Displays ratio method called disc coning

FIG. 07 Steps in group timing system and item numbers referring to durations

FIG. 08 Example of how group timing system allows chambers to be daisy chained and stacked in all directions infinitely without the intake valve and exhaust valve of any chamber being simultaneously open and item numbers referring to durations described in group timing system

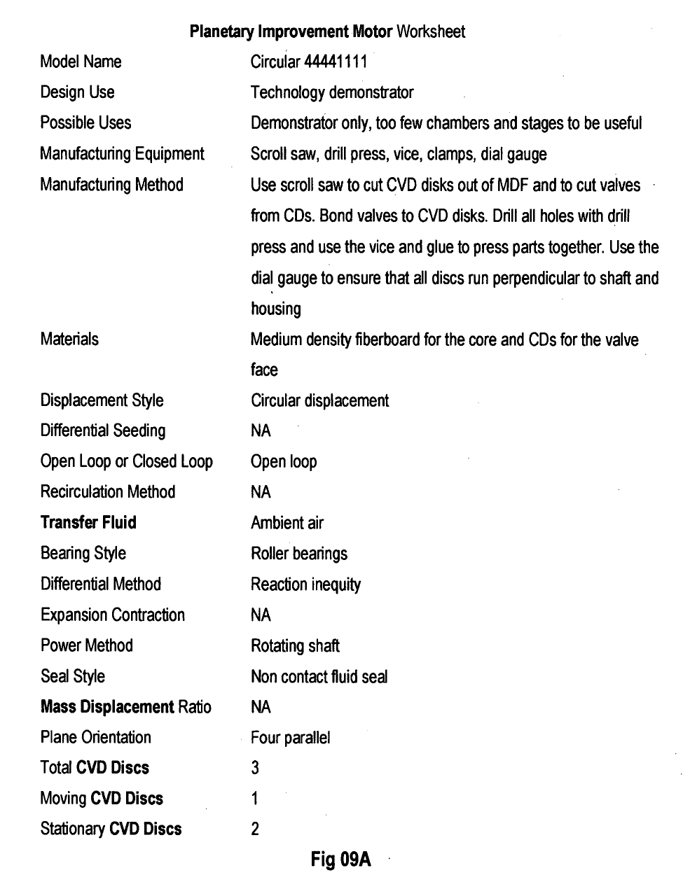

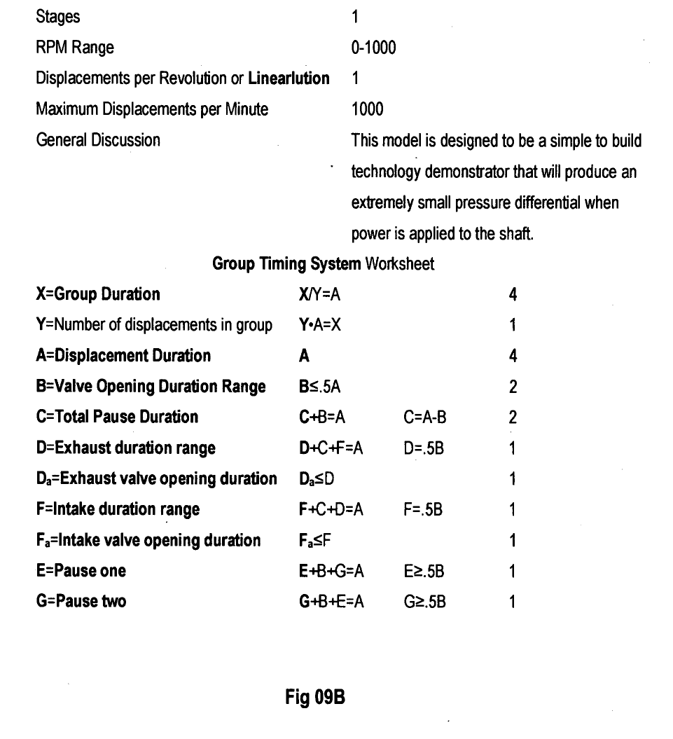

FIG. 09-14 Planetary Improvement Motor Circular 44441111

FIG. 09A Circular 44441111 Planetary Improvement Motor worksheet (see legend [028])

FIG. 09B Circular 44441111 Group Timing System worksheet (see legend [029])

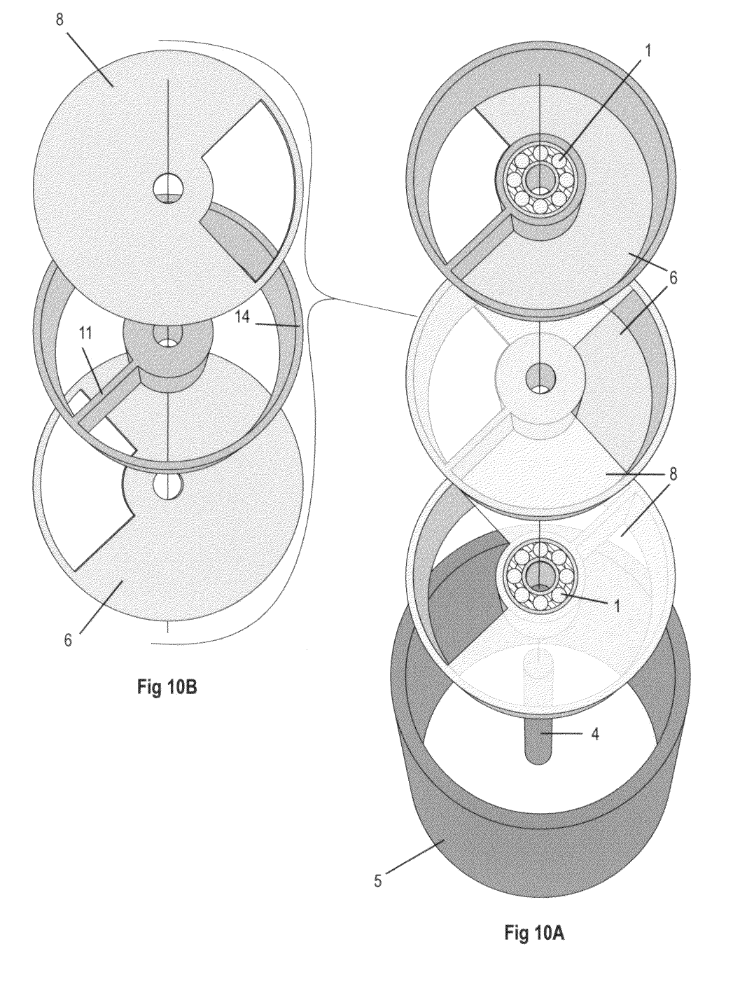

FIG. 10A Circular 44441111 Three Dimensional view (see legend [037])

FIG. 10B Circular 44441111 Exploded view of the moving CVD disc that contains the chamber

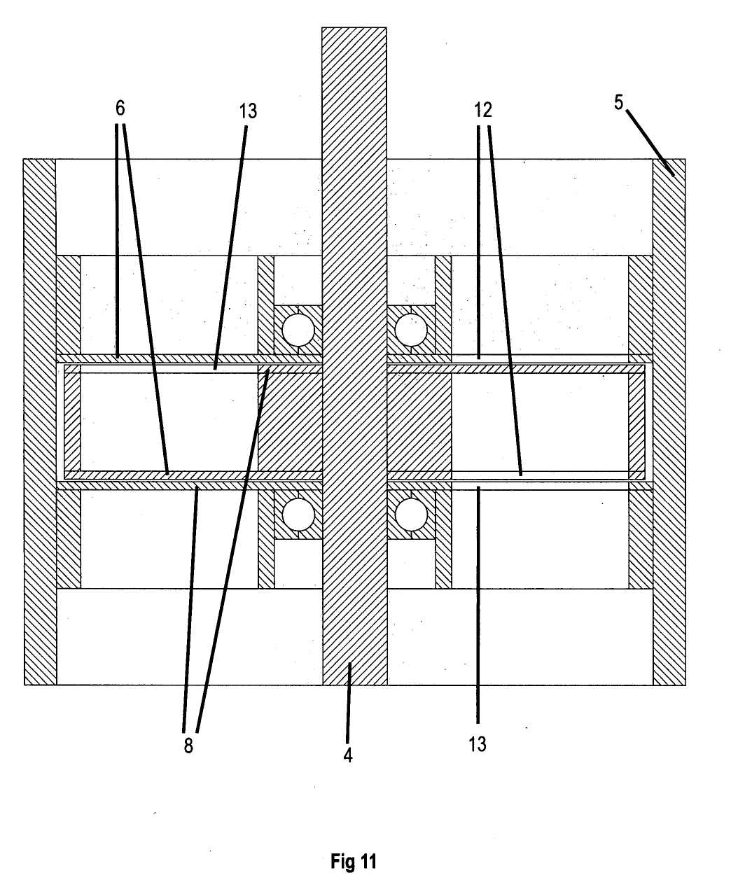

FIG. 11 Circular 44441111 Cross Section view (see legend [038]) as if motor split directly in the middle

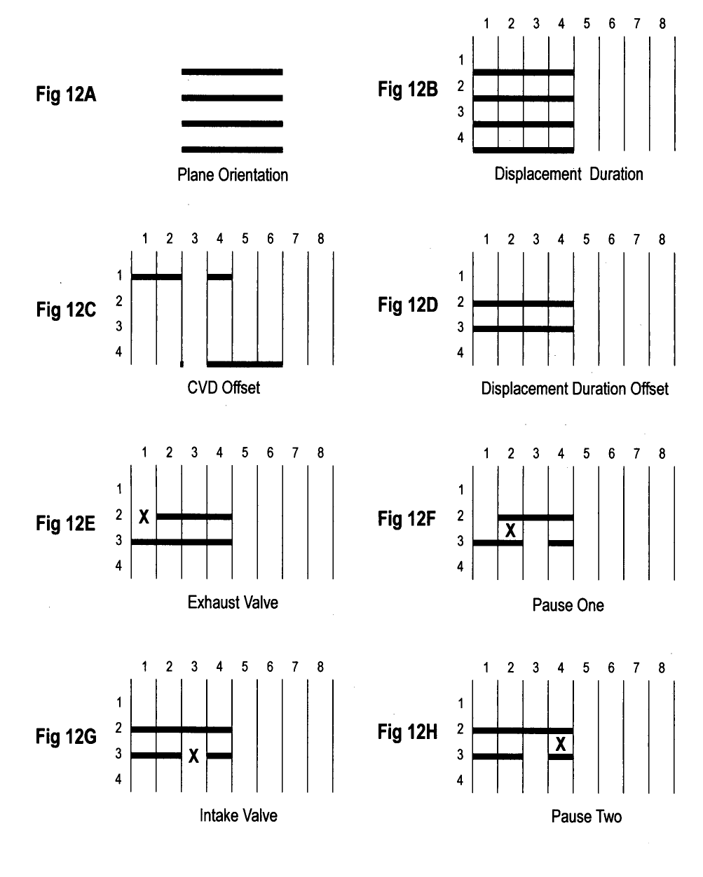

FIG. 12A-H Circular 44441111 Group Timing System view (see legend [039]) abstract time view

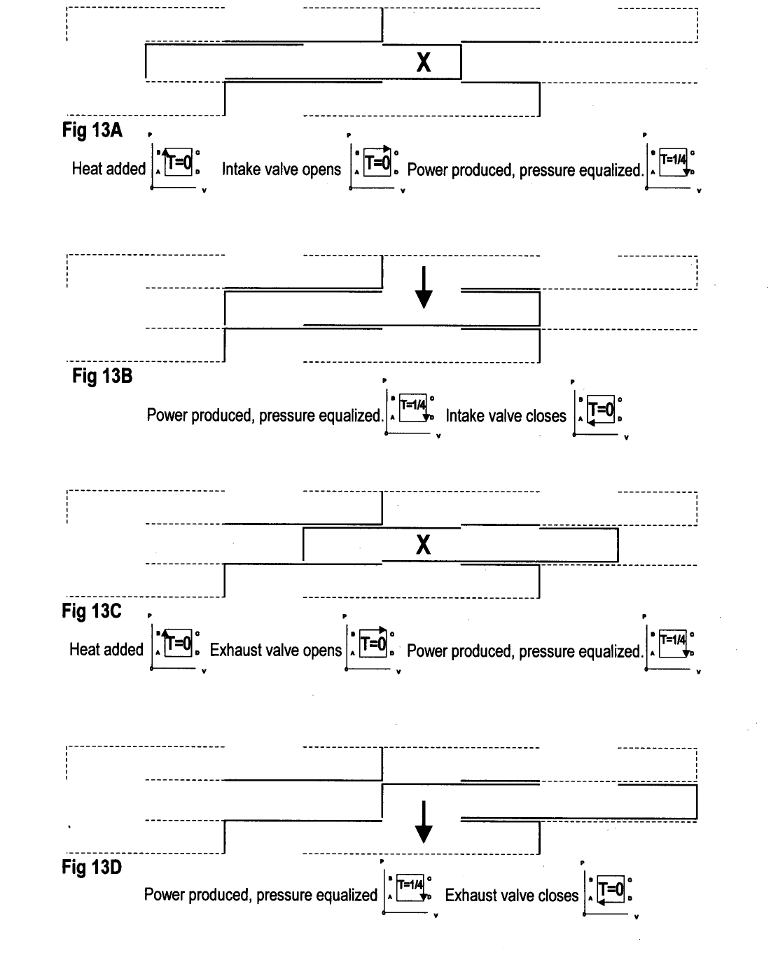

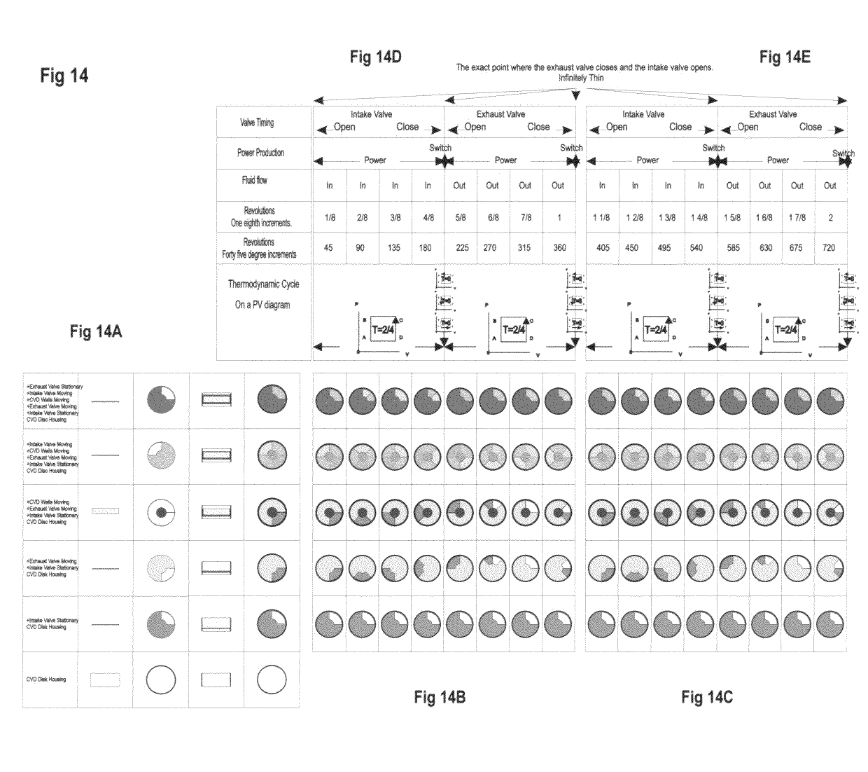

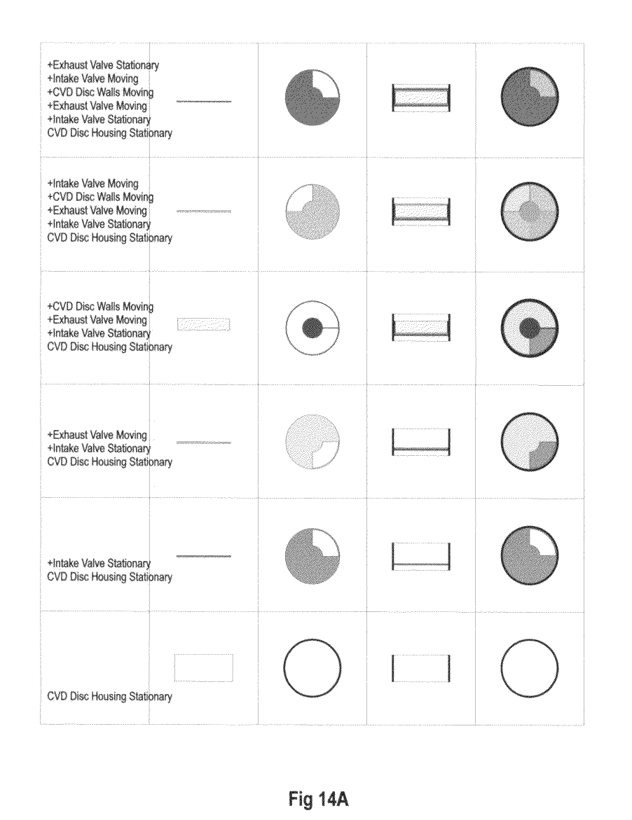

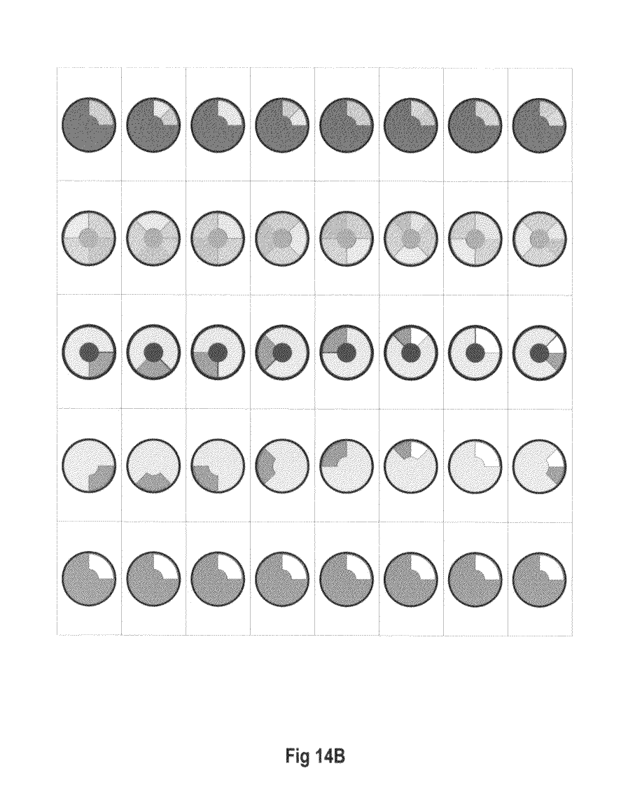

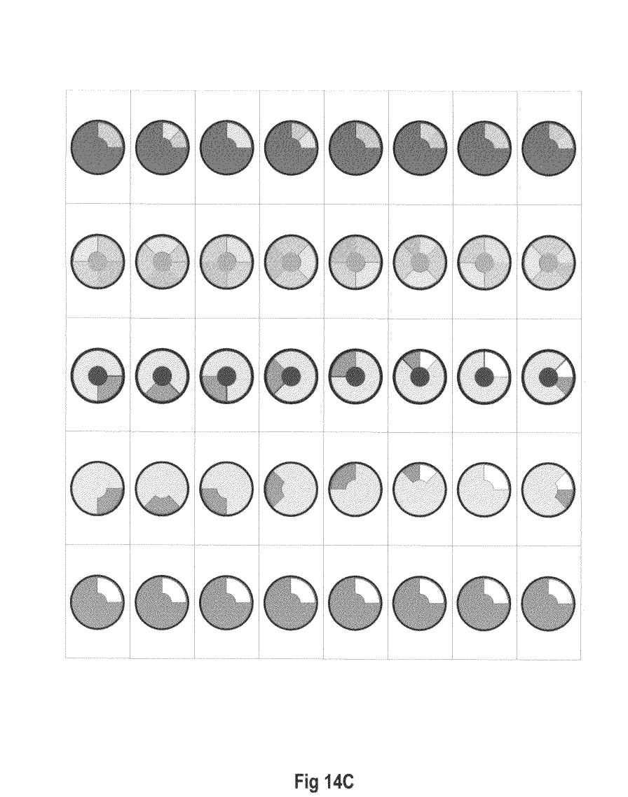

FIG. 13A-D Circular 44441111 Abstract Cutaway and PV Loop (see legend [040]) abstract view

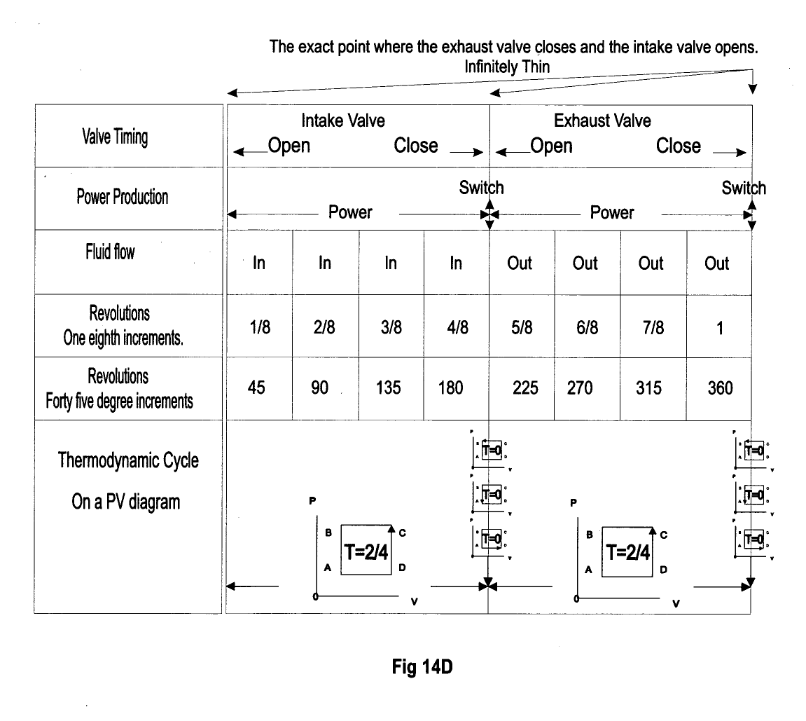

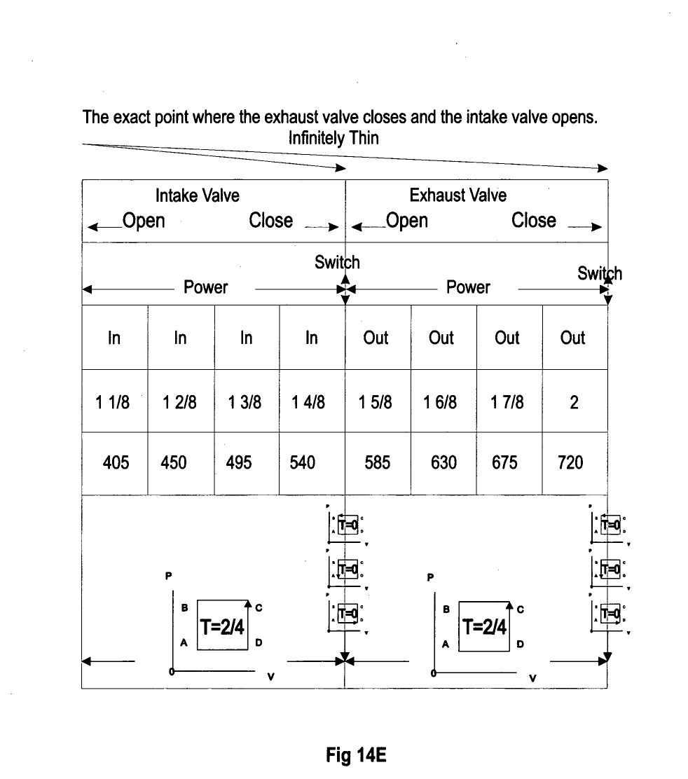

FIG. 14 Circular 44441111 A whole view that shows the proper arrangement of partial views 14A-14E which illustrate the function of various components of Planetary Improvement Motors during operation

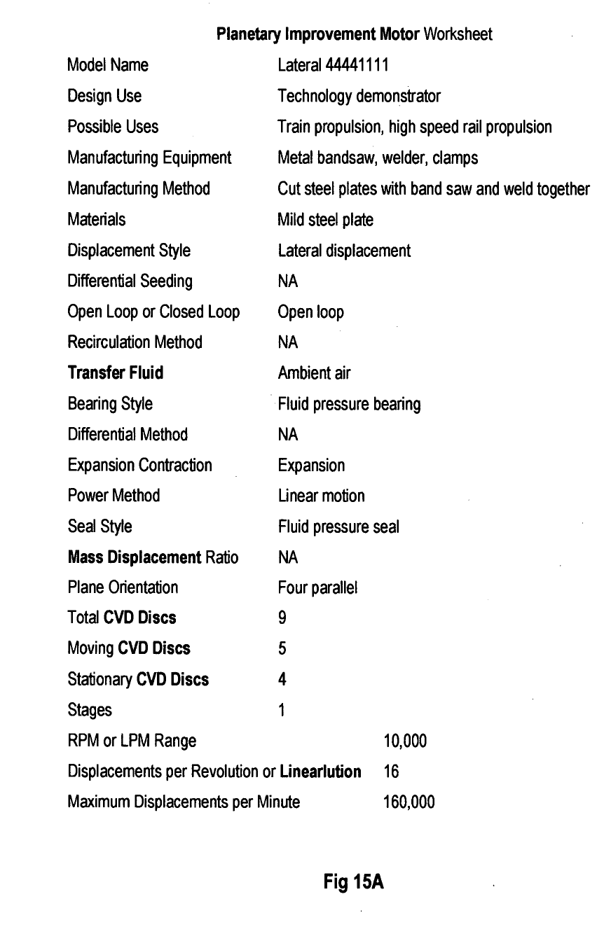

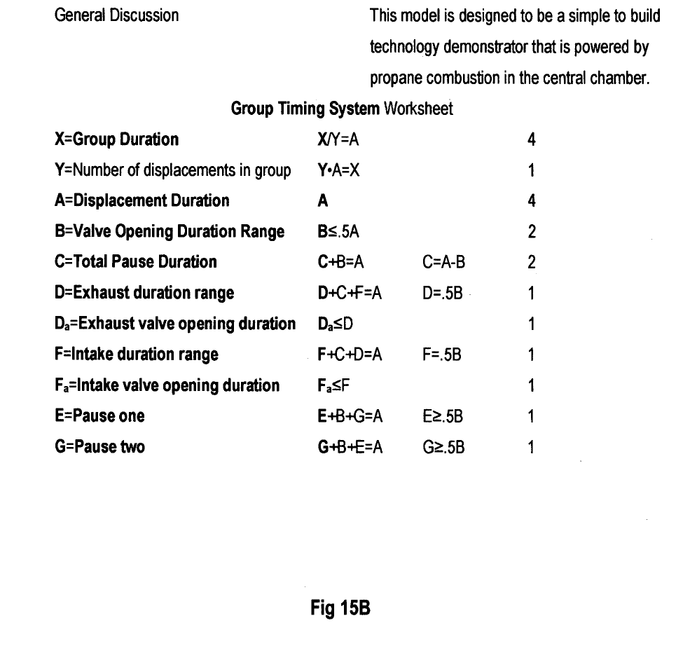

FIG. 15-19 Planetary Improvement Motor Lateral 44441111

FIG. 15A Lateral 44441111 Planetary Improvement Motor worksheet (see legend [028])

FIG. 15B Lateral 44441111 Group Timing System worksheet (see legend [029])

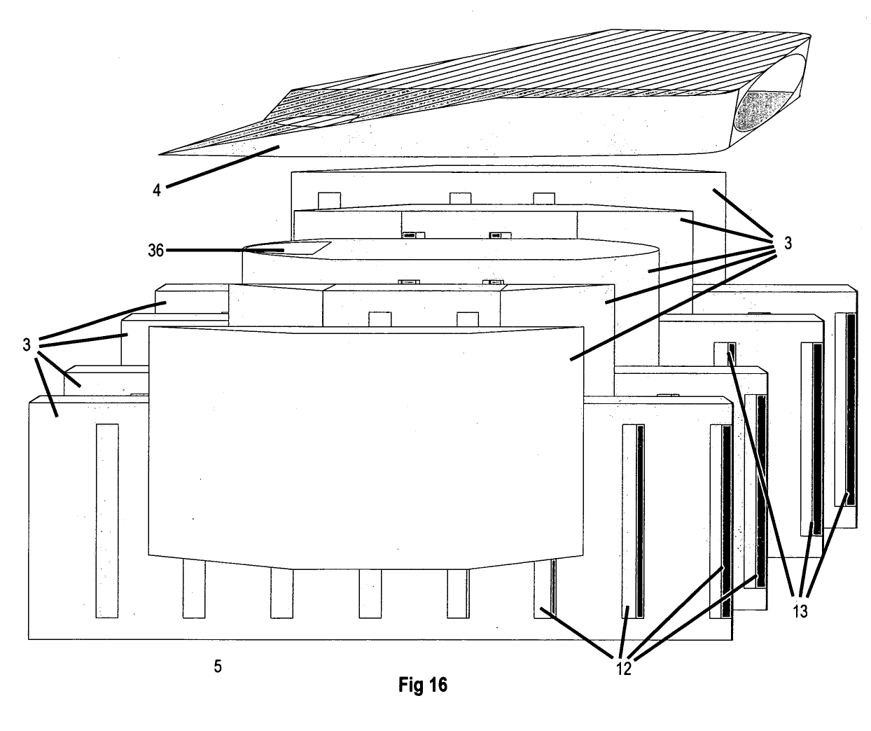

FIG. 16 Lateral 44441111 Three Dimensional view (see legend [037])

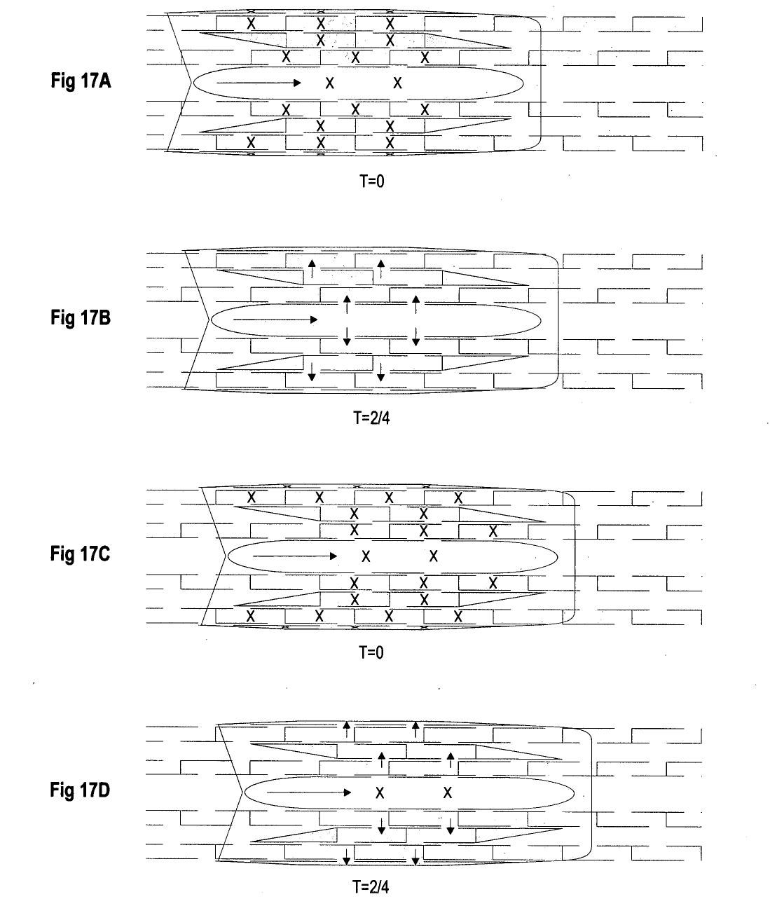

FIG. 17A-D Lateral 44441111 Cross section view (see legend [038]) from top down with top removed during one displacement, arrows indicate fluid in motion and Xs indicating fluid in closed chamber

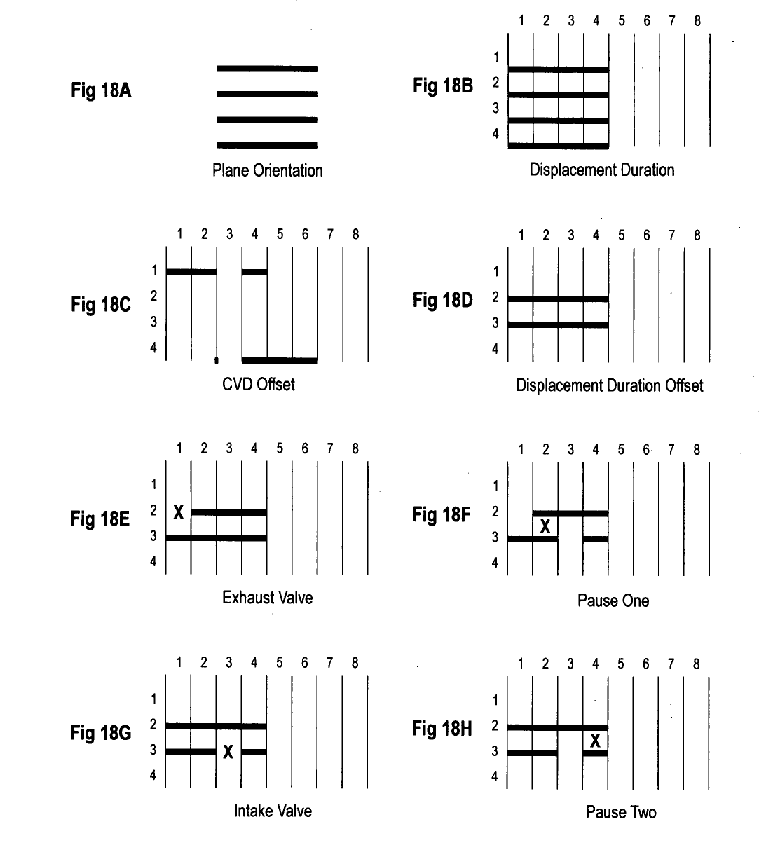

FIG. 18A-H Lateral 44441111 Group Timing System view (see legend [039]) abstract time view

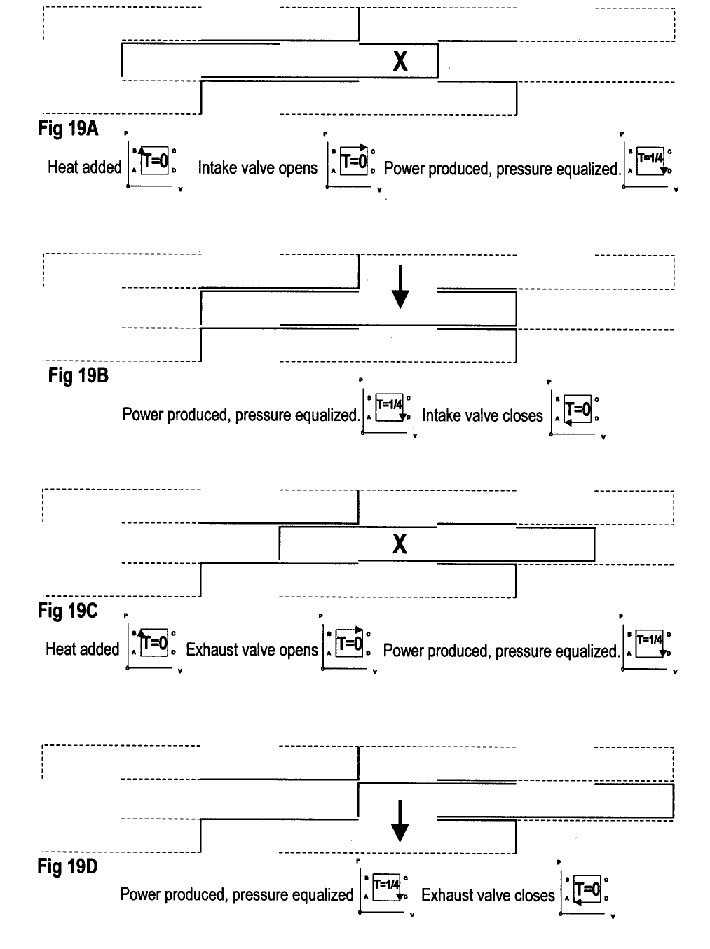

FIG. 19A-D Lateral 44441111 Abstract Cutaway and PV Loop (see legend [040]) abstract view

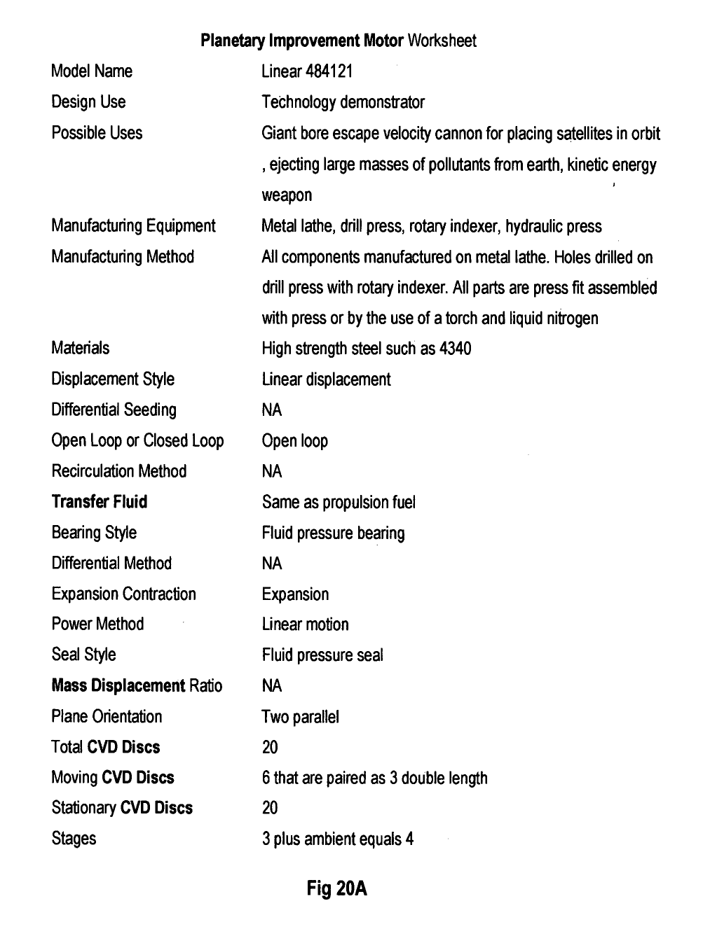

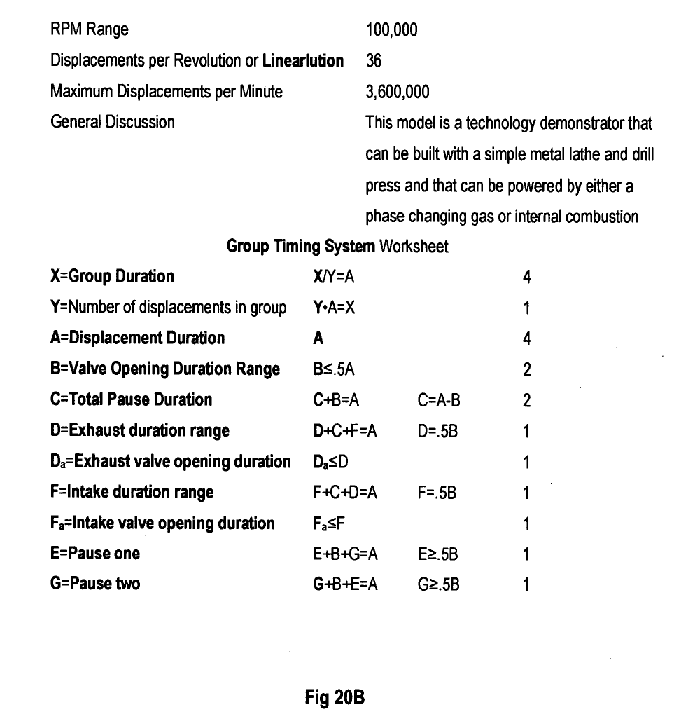

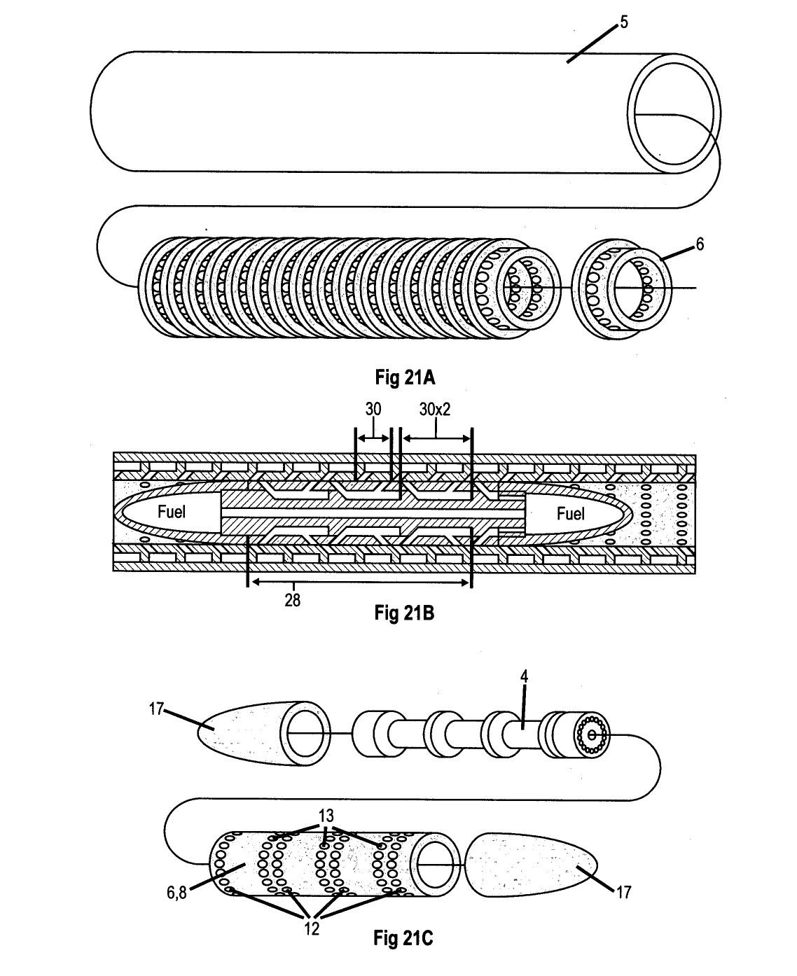

FIG. 20-24 Planetary Improvement Motor Linear 484121

FIG. 20A Linear 484121 Planetary Improvement Motor worksheet (see legend [028])

FIG. 20B Linear 484121 Group Timing System worksheet (see legend [029])

FIG. 21A Linear 484121 Three Dimensional view (see legend [037]) of stationary components

FIG. 21B Linear 484121 Cross section of Planetary Improvement Motor split in middle with item numbers for Group Timing System durations

FIG. 21C Linear 484121 Three Dimensional view (see legend [037]) of moving components

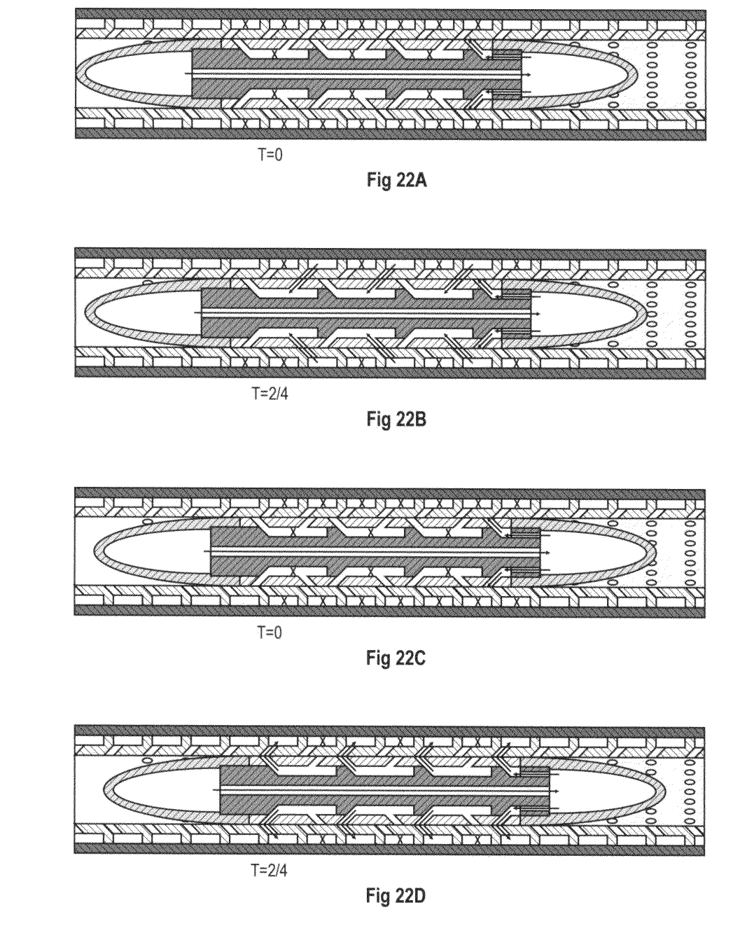

FIG. 22A-D Linear 484121 Cross Section view (see legend [038]) of Planetary Improvement Motor split directly in half, during one displacement; arrows indicate fluid in motion and Xs indicating fluid in closed chamber

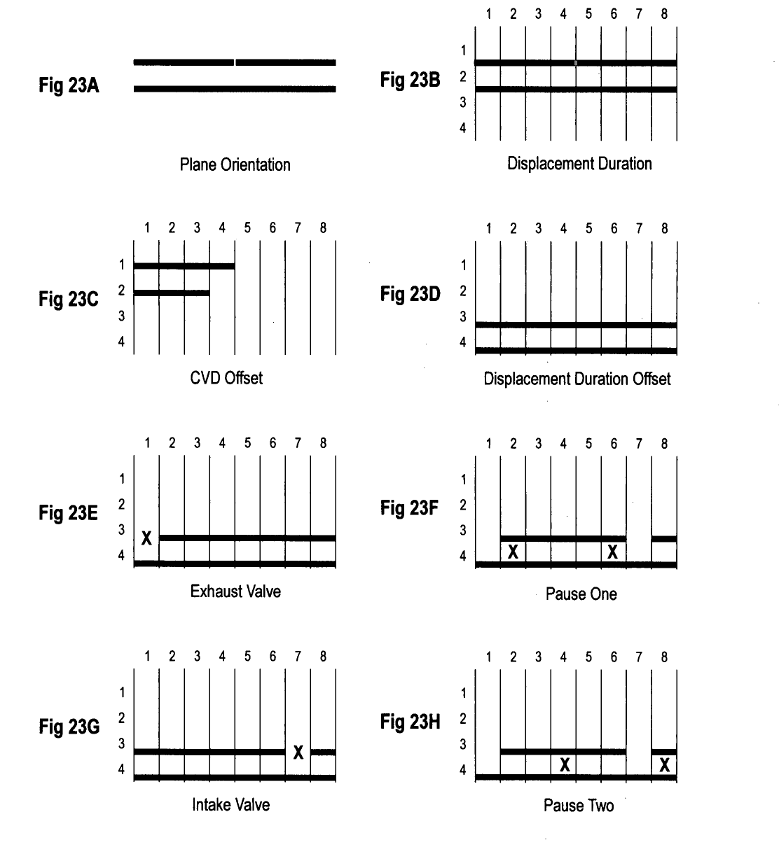

FIG. 23A-H Linear 484121 Group Timing System view (see legend [039]) abstract time view

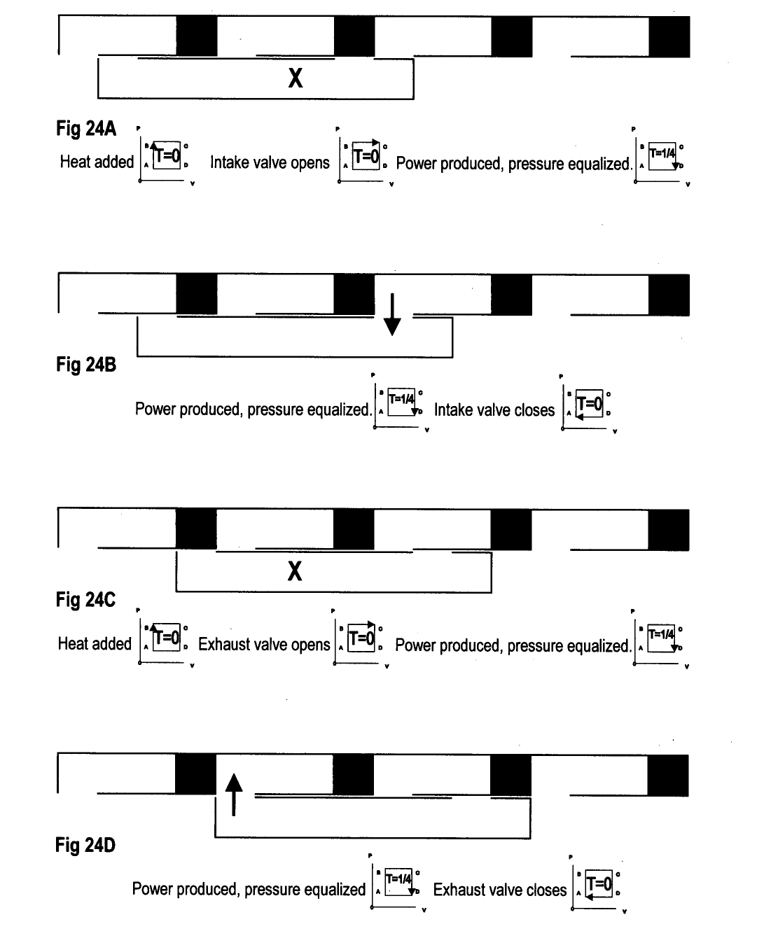

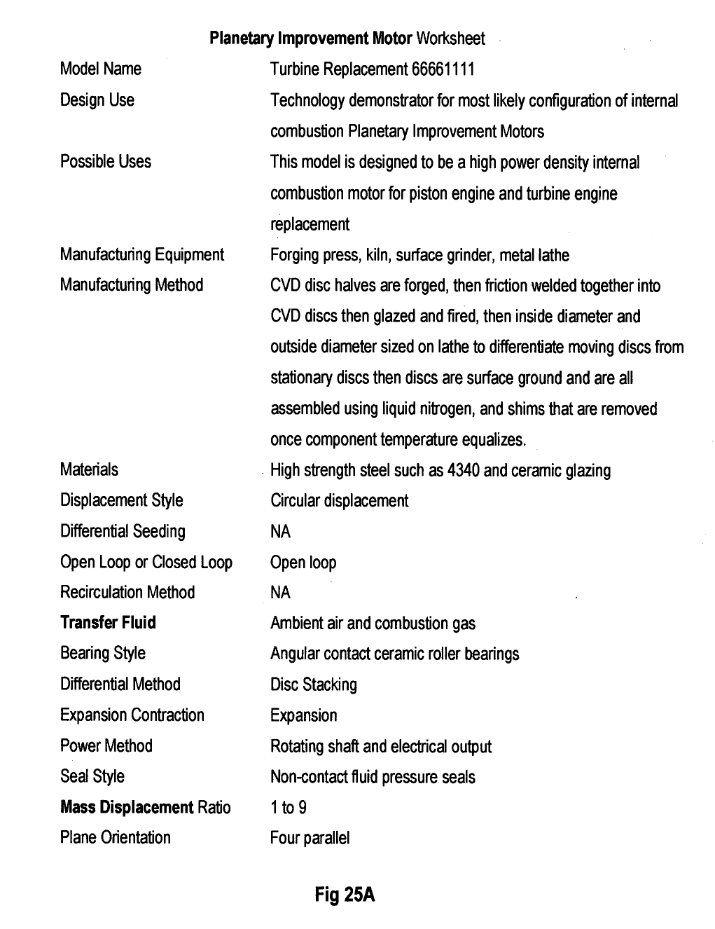

FIG. 24A-D Linear 484121 Abstract Cutaway and PV Loop (see legend [040]) abstract view

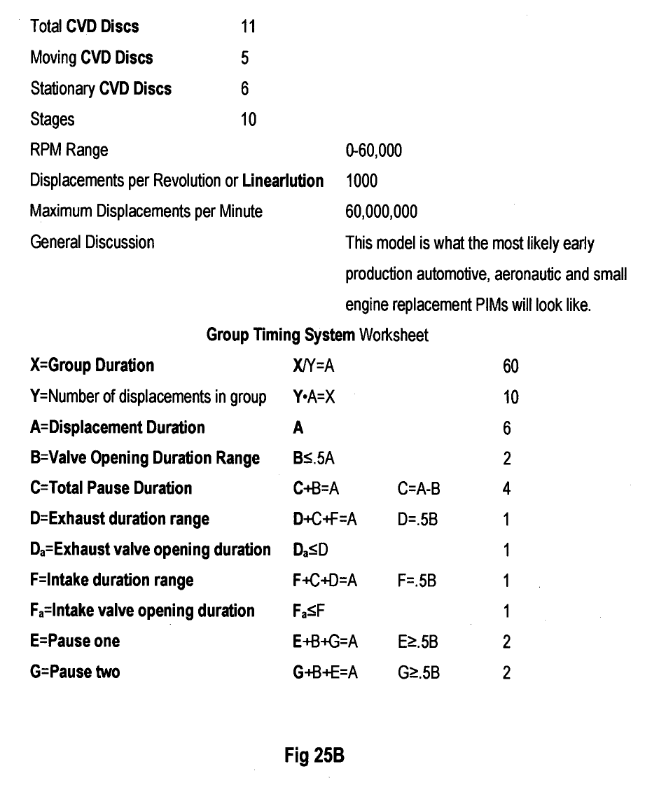

FIG. 25-31 Planetary Improvement Motor Turbine Replacement 66661111

FIG. 25A Turbine Replacement 66661111 Planetary Improvement Motor worksheet (see legend [028])

FIG. 25B Turbine Replacement 66661111 Group Timing System worksheet (see legend [029])

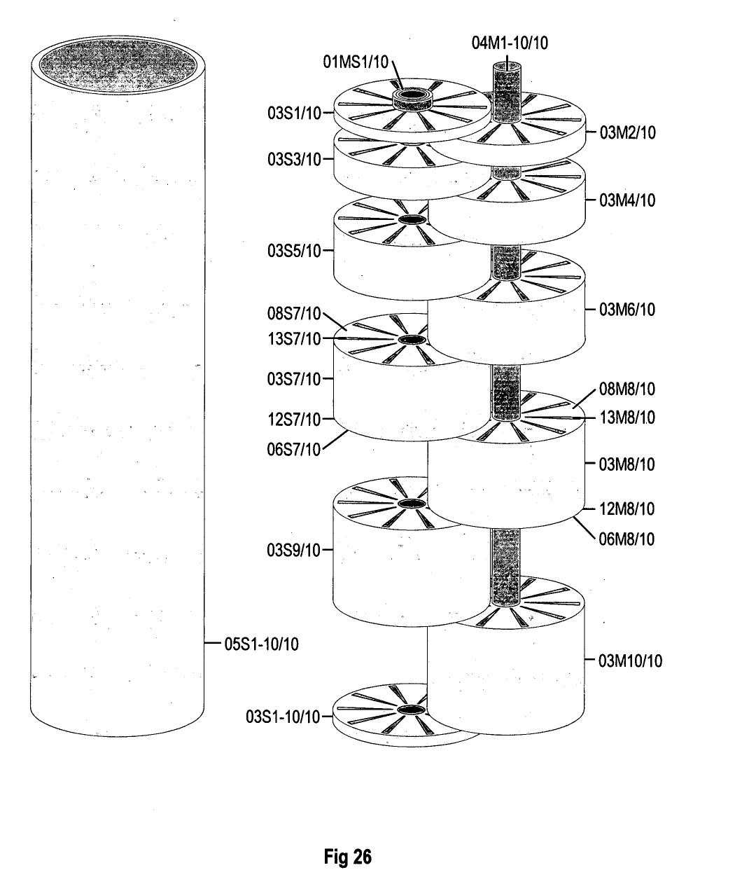

FIG. 26 Turbine Replacement 66661111 Three Dimensional view (see legend [037])

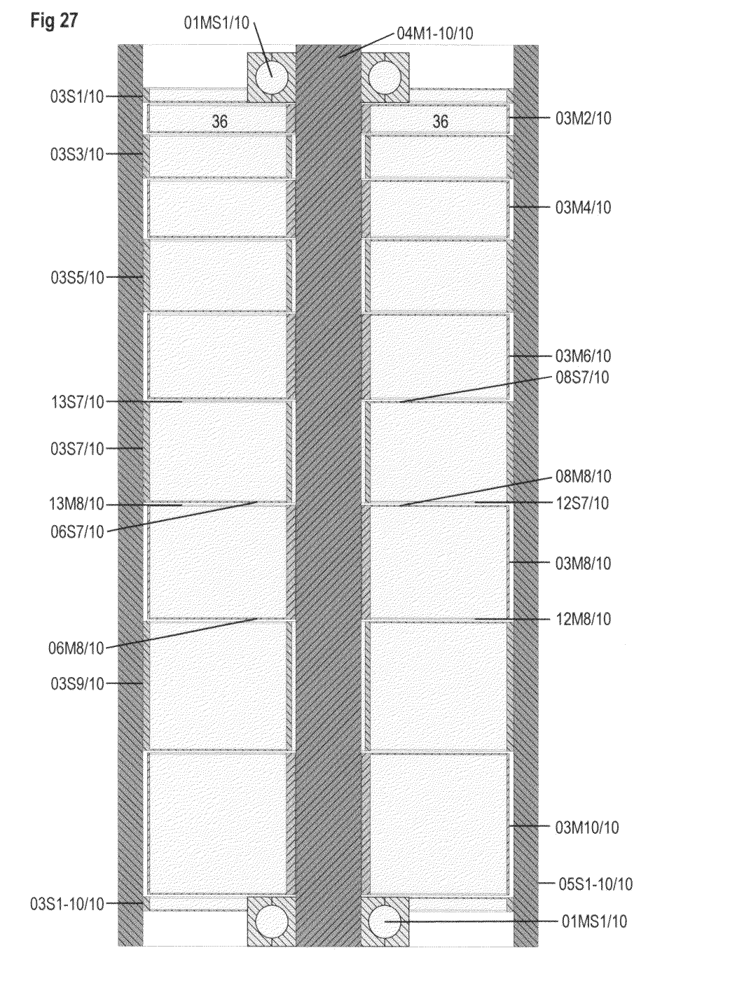

FIG. 27 Turbine Replacement 66661111 Cross Section view (see legend [038]) of Planetary Improvement Motor split directly in half, during one displacement; arrows indicate fluid in motion and Xs indicating fluid in closed chamber

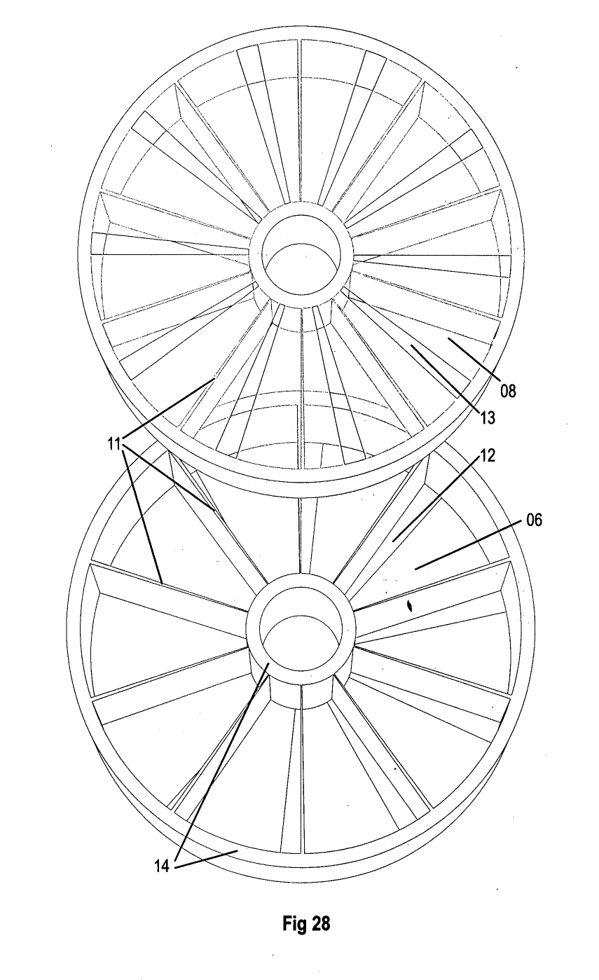

FIG. 28 Turbine Replacement 66661111 Exploded view of two CVD disc halves used to make one CVD disc with the top layer transparent

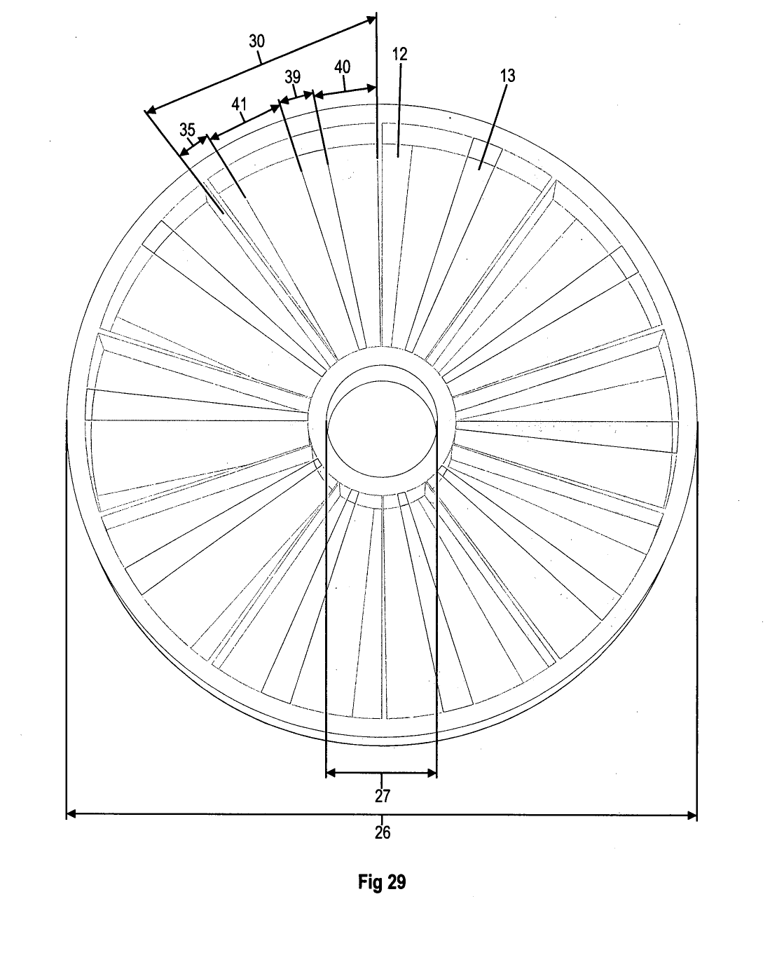

FIG. 29 Turbine Replacement 66661111 Exploded view of one CVD disc with the top layer transparent

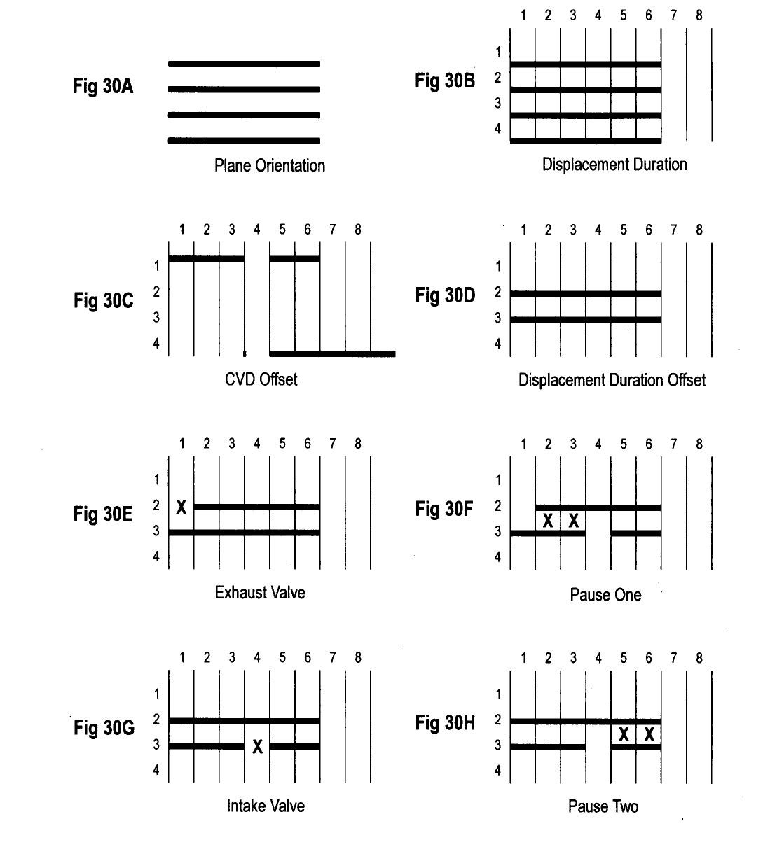

FIG. 30A-H Turbine Replacement 66661111 Group Timing System view (see legend [039]) abstract time view

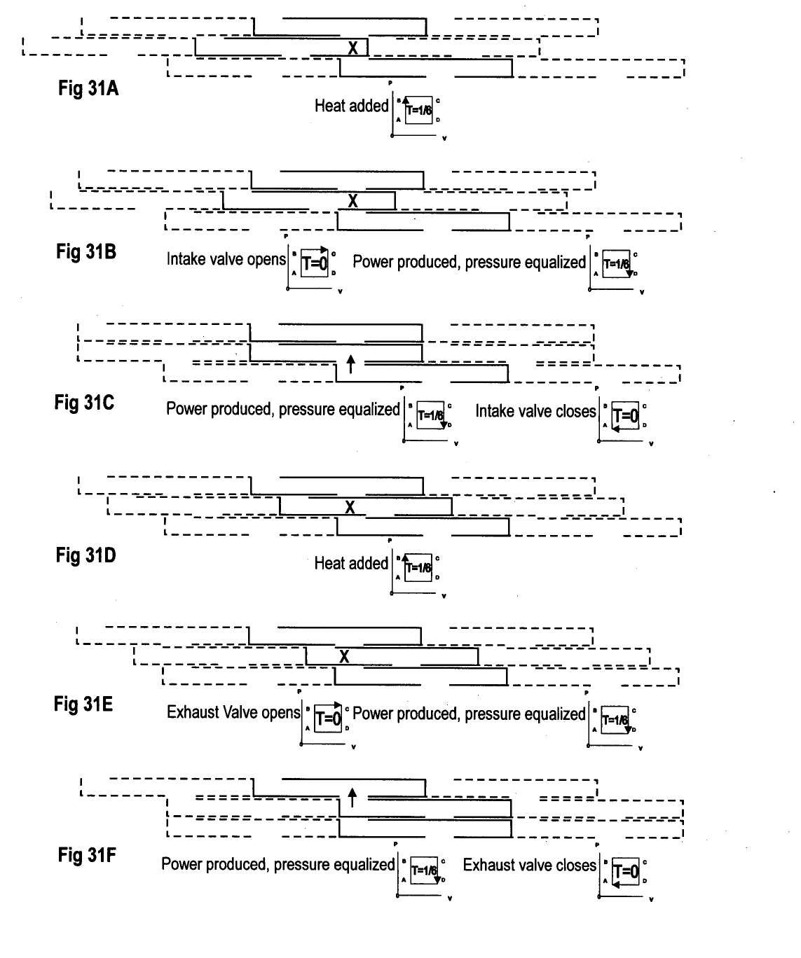

FIG. 31A-F Turbine Replacement 66661111 Abstract Cutaway and PV Loop (see legend [040]) abstract view

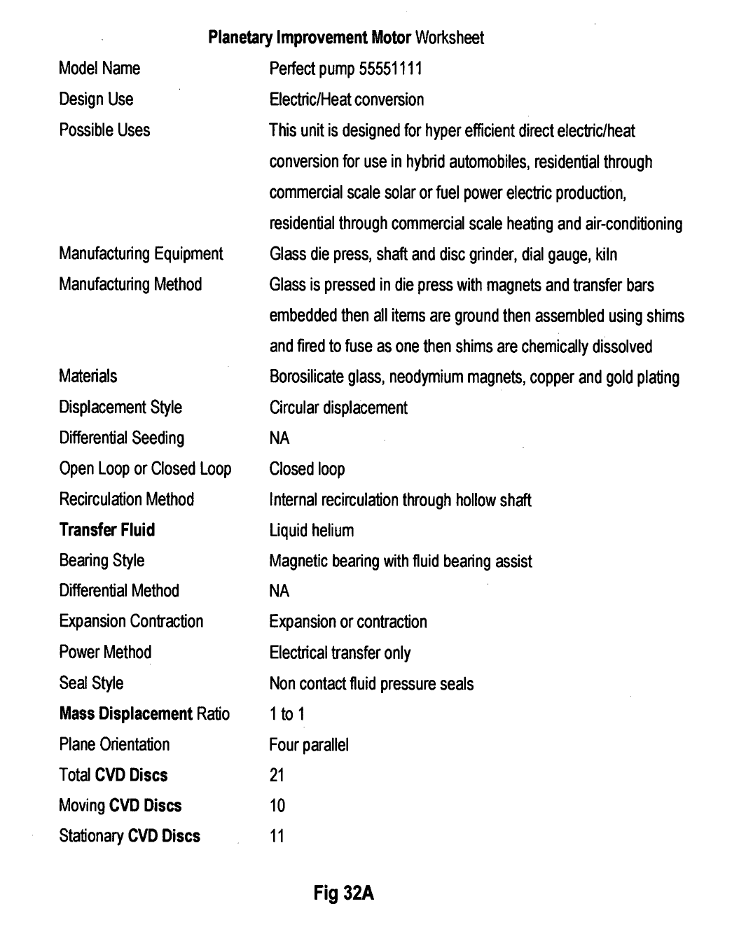

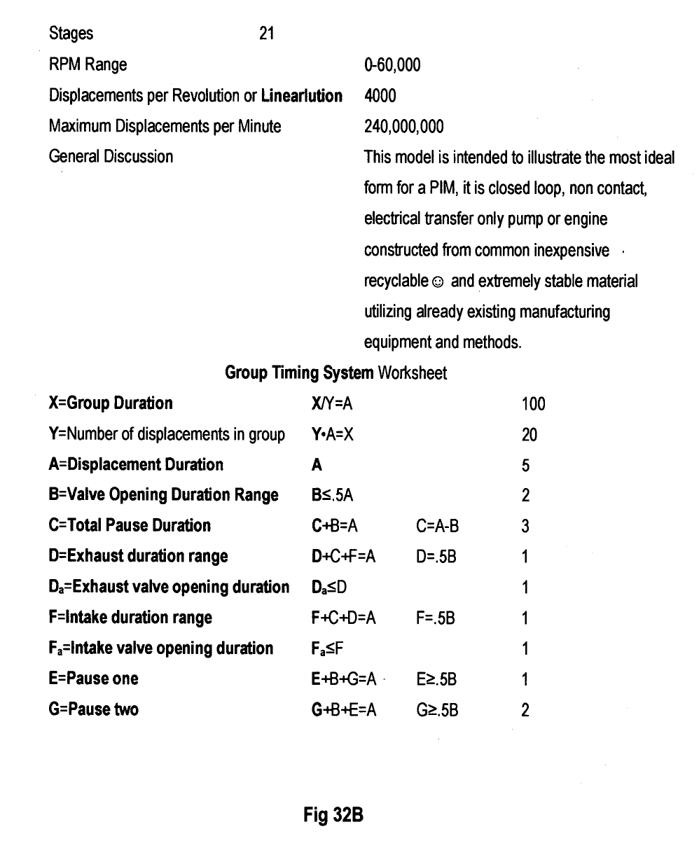

FIG. 32-37 Planetary Improvement Motor Perfect Pump 55551111

FIG. 32A Perfect Pump 55551111 Planetary Improvement Motor worksheet (see legend [028])

FIG. 32B Perfect Pump 55551111 Group Timing System worksheet (see legend [029])

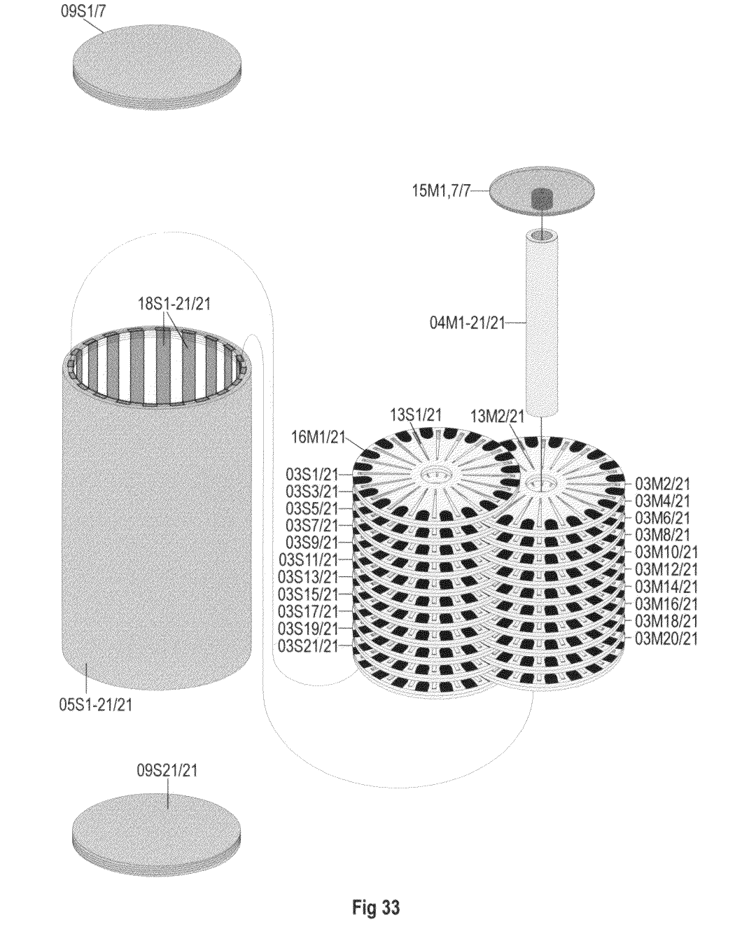

FIG. 33 Perfect Pump 55551111 Three Dimensional view (see legend [037])

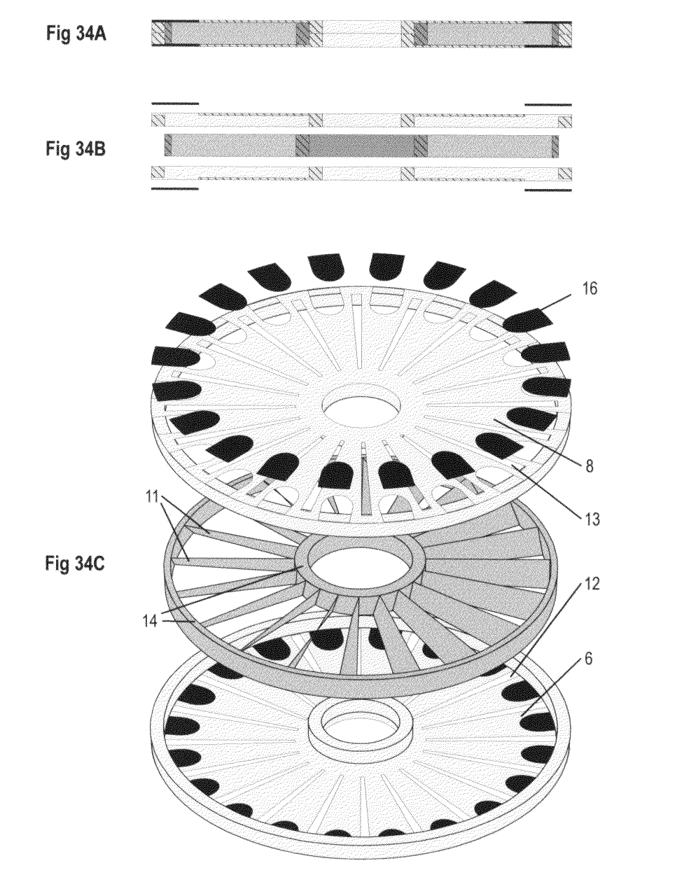

FIG. 34A Perfect Pump 55551111 Exploded sectional view of one CVD disc spit in equal halves

FIG. 34B Perfect Pump 55551111 Exploded sectional view of one disassembled CVD disc spit in equal halves

FIG. 34C Perfect Pump 55551111 Exploded three dimensional view of one disassembled CVD disc

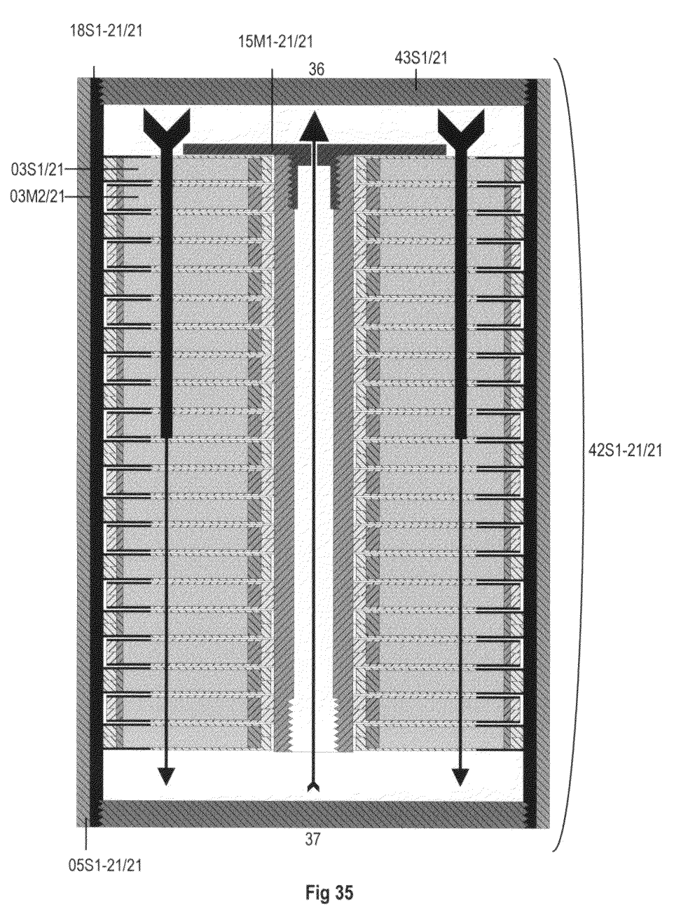

FIG. 35 Perfect Pump 55551111 Cross Section view (see legend [038]) of Planetary Improvement Motor split directly in half, during one displacement; arrows indicate fluid

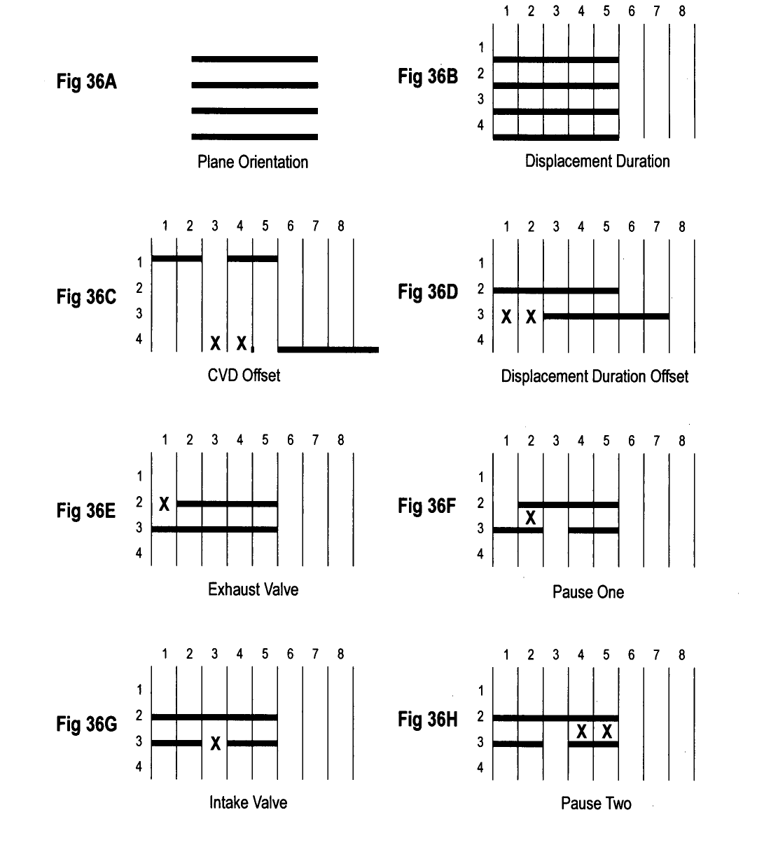

FIG. 36A-H Perfect Pump 55551111 Group Timing System view (see legend [039]) abstract time view

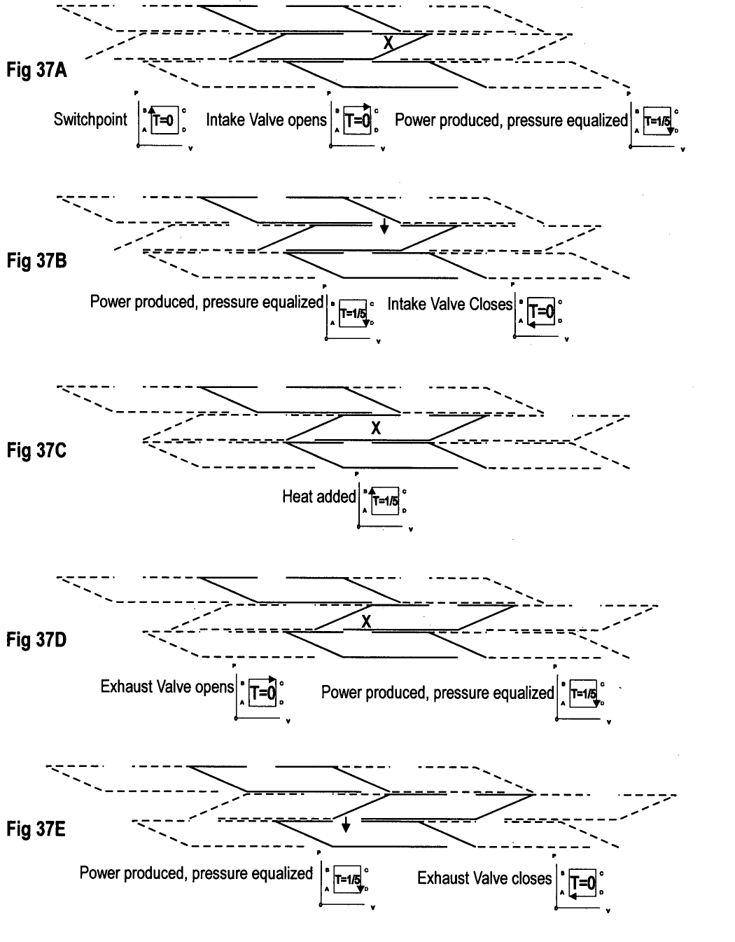

FIG. 37A-E Perfect Pump 55551111 Abstract Cutaway and PV Loop (see legend [040]) abstract view

### DETAILED DESCRIPTION OF THE INVENTION

The Planetary Improvement Motor (PIM) is an engine whose function is based on many extremely simple but completely new concepts. In order to make it easier to understand I will first give a brief explanation of how the PIM works. I will then break it down into detailed concepts. The information provided will allow anybody with the proper knowledge, to verify the claims.

A PIM can have as few as two parts; One CVD disk housing assembly, one CVD disk shaft assembly. The housing and shaft each have CVD disks mounted in alternating fashion, one to the shaft, one to the housing, one to the shaft etc. . . . These CVD disks contain chambers and a method for controlling the flow of fluid through the chambers. The discs don't contact each other. The valves are simply openings in the discs and the seals are the narrow tolerances between the discs.

The reason that the PIM can operate with no contact seals is that it is faster for the fluid to go through the motor creating displacement and imparting rotational or linear motion than to leak through the seals and not impart motion. Another reason that it is possible to have non contact seals is that the PIM counts on leakage and makes up for it by not trying to convert the energy with one large pulse of power but instead with very many small pulses. Also in a PIM any leakage from one engine stage leaks only directly to the following stage in series resulting in no net loss. Stages can simply be stacked on to the PIM until desired efficiency or pressure is achieved.

How does the Pim Displace with Only One Moving Part and No CONTACT SEALS? In order to properly answer this question first we have to discuss exactly what displacement is and what we think it is. The first concept is the difference between actual displacement and mass displacement. Mass displacement is the mass of a displaced volume. For this discussion we are primarily interested in mass displacement.

A life vest displaces water in a completely different way than a piston displaces air. With a life vest we can say that its mass displacement is both permanent and constant. It is permanent because it is impermeable and physically displaces a volume of water. It is constant because water is non-compressible fluid. One cu ft of water has the same mass displacement at 50,000 feet elevation as it does at sea level.

A piston in an engine has a mass displacement that is both temporary and variable. It is temporary because it relies on seals and valves to maintain a pressure differential. It is variable because air is a compressible fluid. One cu ft of air at 50,000 ft elevation does not have the same mass displacement as one cu ft at sea level due to the difference in air pressure.

In both examples the actual displacement remains unaffected by air pressure and time. The mass displacement of the life vest also remains unaffected by air pressure and time. However the mass displacement of the piston engine is affected by both air pressure, and time. This is why an automobile engine produces less power in the mountains than by the beach. The mass displacement of the engine is not fixed.

This concept of mass displacement is very important to understanding the rest of the concepts. A piston engine has a fixed actual displacement with a mass displacement that is both temporary and variable. A PIM engine has a fixed actual displacement with a mass displacement that is both temporary and variable. Both are the same.

In a piston engine, a piston and a volume of air take turns occupying the same space. In a PIM one contained air volume (a DDC) and another contained air volume (another DDC) take turns occupying the same space. Both are the same except that in a piston engine the contained air volume is displaced by a piston and in a PIM it is displaced by a separate contained air volume.

I STILL DON'T UNDERSTAND. HOW CAN FLUID BE POSITIVELY DISPLACED WITHOUT CHANGING THE VOLUME OF THE CHAMBER? The PIM uses a new form of positive displacement called constant volume displacement “CVD”. Constant Volume Displacement “CVD” is form of cyclic positive displacement that displaces a fluid from one pressure zone to a different pressure zone by containing fluid within a fixed volume chamber that has at least one intake port and one exhaust port, then adding or subtracting energy to or from the fluid, the resulting change in energy within the chamber displaces fluid into or out from the chamber and produces work from both the displacement into the chamber and the displacement out of the chamber.

A piston engine contains fluid in a chamber then adds heat in order to expand the fluid and displace the fluid and the piston. Whereas a PIM contains a fluid in a chamber then adds heat in order to expand the fluid and displace the fluid and the chamber it is contained in. Both are the same except that a piston engine displaces both fluid and a piston and a PIM displaces both fluid and a fluid chamber.

A piston engine can be configured for linear reciprocal motion and can also be used to create circular motion through the addition of a connecting rod and crankshaft and various other associated components. A PIM can be configured for linear reciprocal motion, as well as linear unidirectional motion, as well as circular motion, without the addition or subtraction of any components.

A reasonably analogous example of what a CVD pump (work to heat) is doing. Would be to take a pressure cooker and hold it out a moving car window facing open side forward creating positive pressure inside of the pot. Then very quickly bringing the pot into the car and equalizing the pressure from the pot with the pressure in the car therefore increasing the pressure in the car. Then repeat this procedure millions of times per second. It may only be a tenth of a pound of pressure difference that is contained within the pot with a total mass displacement of one gram. But if you multiply this small mass displacement of only one gram times a million you wind up with a total mass displacement of more than one ton. That is a lot of fluid.

How is it Possible for the Pim to Contain Enough Pressure within a DDC TO BE USEFUL FOR POWER PRODUCTION AND HAVE NO CONTACT SEALS? In an internal combustion piston engine a very high pressure is contained for a very short interval within a cylinder and an attempt is made to convert as much of the energy as possible in only one pulse of work before the gas is exhausted. In a PIM Instead of trying to convert energy to work in one big pulse, many millions, billions, or even trillions of itsy bitsy teensy weensy itty bitty tiny pulses are used. It is possible for a PIM to produce a nearly infinite number of individual power pulses and thermodynamic cycles within one revolution. Model called Perfect Pump 55551111 produces 8,000 individual thermodynamic loops and power pulses for one revolution. At only 6,000 revolutions per minute a total of 48,000,000 individual power pulses and thermodynamic loops are produced by this pocket sized PIM in only one minute. A four stroke, four cylinder automobile engine operating at 6,000 revolutions per minute produces only, 6,000 individual power pulses and thermodynamic loops. When you compare 6,000 to 48,000,000 it is easy to see why a DDC within the PIM only needs to contain a very small pressure difference for a very short interval and why non contact seals work. Several new principles are employed in order to achieve this.

The first technique is Forced Loop Pairing “FLP”. In a piston engine every displacement of fluid that passes one time through one cylinder can only produce a maximum one pulse of work. A four stroke produces one work pulse and thermodynamic cycle for every two fluid displacements. A two stroke produces one work pulse and thermodynamic cycle for every one fluid displacement. A PIM however produces one pulse of work and one thermodynamic cycle as the fluid enters a chamber, and one pulse of work and one thermodynamic cycle as fluid exits a chamber. That is two work pulses and two complete thermodynamic cycles for every one displacement of fluid through one chamber. In other words FLP produces four times the thermodynamic cycles per displacement as a four stroke and two times the thermodynamic cycles per displacement as a two stroke. You can think of a PIM as a one stroke.

The second technique is displacement stacking. Displacement Stacking is to displace fluid more than one time through one chamber during one revolution of a revolving displacement pump or engine, or one linearlution of a linear displacement or lateral displacement pump or engine. For example in a piston engine, a piston can displace fluid an absolute maximum of one time for each one revolution of the crankshaft. In a PIM the number of times a single DDC can displace fluid in one revolution is the same as the number of DDCs per CVD disk squared. For example if a CVD disk contains 20 DDCs that means that each DDC can displace a maximum of 20 times per revolution. Therefore 1 revolution of one CVD disk that contains 20 DDCs per CVD disk yields 400 individual fluid displacements (20 DDCs 20 times each per revolution). This makes the mass displacement of a PIM the number of DDCs per CVD disk squared, times the average mass displacement per work pulse, times (the total CVD disks minus one). This will yield the approximate mass displacement for one revolution or linearlution of a PIM.

The third technique is stage stacking. Stage stacking is the containment of more than one stage of a multistage displacement engine in a manner such that the leakage from one stage (that is normally wasted) is contained and goes directly to the next stage in series with no net loss. This technique is used in the PIM when multiple CVD disks are employed in series. Stage stacking causes the small individual pressure differentials that occur at each CVD disk to become cumulative. This means that in order to get a higher total differential you simply stack more CVD disks within a PIM. The maximum differential a PIM can produce is limited only by the strength of the housing and its ability to maintain integrity.

When forced loop pairing, displacement stacking, and stage stacking are combined the effect becomes extremely evident when viewing Perfect Pump 55551111. Perfect Pump contains 10 moving and 11 stationary CVD disks with 20 DDCs per CVD disk and a total reaction of 0.01 nm per individual torque pulse. The result is a total of 8000 torque pulses per one revolution yielding a total of 800 nm torque per second at 6000 rpm. OUTRAGEOUS!

IT IS IMPOSSIBLE TO HAVE ZERO NET ENERGY LOSS FOR A FLUID WHEN TRAVELING FROM ONE STAGE OF A MULTI STAGE PUMP OR ENGINE TO THE NEXT STAGE BECAUSE OF ENTROPY. WRONG! Basically it's like this. Entropy and the universe in general, are always described as functions of energy. Energy requires time in order to exist because without time there is no movement and without movement there is no energy, only energy potential. Everything in existence is actually a direct function of time not energy. Looking at everything in the universe as being a function of time and not as a function of energy will lead to other breakthroughs in addition to the PIM. The fact is that entropy is not really a function of energy but in fact a function of time. Therefore if all things are equal, the more time and energy a system has the more entropy potential that the system has. If we want to reduce the entropy of a system, than we have to reduce the time or the energy for that system. So if we want to retain the energy but still reduce the entropy than the only option left is to reduce the time fluid takes to travel from one stage to the next stage.

The way that a PIM can reduce and even eliminate the time between stages is that the exact moment that the exhaust valve for the first moving chamber closes the intake valve the next moving chamber opens. This is because there is no exhaust only stroke when fluid moves from one stage of a PIM to the next stage in series. Every exhaust stroke from one stage is the intake stroke for the following stage. It is possible to do this by holding the fluid in stationary chambers between the moving chambers. This repeated transfer of fluid between stationary and moving components is how a PIM converts a change in pressure into motion. It is also how a PIM can divide a difference in pressure infinitely and therefore requires considerably less than one degree of temperature difference for operation.

NOW I UNDERSTAND NON CONTACT SEALING, FORCED LOOP PAIRING, DISPLACEMENT STACKING, AND STAGE STACKING. BUT DOESN'T IT REQUIRE BEARINGS? Yes the PIM does require bearings but they do not have to be contact bearings. The PIM is designed to utilize magnetic bearings, and fluid pressure bearings, or roller bearings, or bush bearings, or any combination. The PIM can be configured to take whatever bearing can locate the components with sufficient accuracy.

Availability of extremely high strength (n50 n53) rare earth neodymium magnets at very reasonable cost has made permanent magnetic bearings a realistic cost effective option. The PIM can utilize magnets for electrical production, or as bearings, or both electrical production and bearings, or no magnets at all just heat to motion. Magnets provide no contact parts to wear out or cause drag. Strong magnets can accurately locate the components providing proper tolerances. Magnets can also be used to generate an electrical field for the purpose of transferring power into and out of a PIM. Non-contact permanent rare earth neodymium magnetic bearings are the most desirable bearing option.

When the PIM is spinning at higher rpm the leakage from the DDCs causes a fluid pressure bearing to occur between the fixed and moving components. This fluid pressure bearing aids the magnetic bearing in ensuring that moving and stationary components do not make unwanted contact with each other.

HOW DOES A FLUID PRESSURE BEARING WORK? There are many types of fluid pressure bearings in common use already. The puck on an air hockey table rides on a fluid pressure bearing. Ice skates ride on a fluid pressure bearing. Fluid pressure bearings work by maintaining sufficient fluid pressure between components to not have physical contact between the components. Turbulence induced sealing “TIS” can be utilized in a PIM in order to improve the effectiveness of a fluid pressure bearing. TIS, is the addition of texture to the internal surfaces. The texture reduces drag by causing fluid layers to adhere to each of the individual surfaces. Which when combined with the constant flow created by the fluid leakage that occurs between differing pressures, result's in the pinching of rolling vortices of fluid between the fluid layers that are attached to the components. In essence without TIS the layer of fluid attached (through surface tension) to the moving surface and the layer of fluid attached to the stationary surface, attach to each other. This causes the moving surface to be attached to the stationary surface with fluid. With TIS the turbulent layer of fluid attached to the moving surface and the turbulent layer of fluid attached to the stationary surface are induced to shear from each other. The layers don't actually attach to each other. Instead, a third layer of fluid vortices separates the fluid layers that are attached to the individual surfaces. These fluid vortices essentially act as ball bearings made of fluid, the turbulent fluid layers attached to moving and stationary surfaces act as the bearing races. The vortices reduce drag by not allowing the fixed and moving surfaces to attach to each other with fluid tension. The vortices increase the sealing efficiency by filling the gap that fluid leaks through, with rolling fluid vortices thereby not allowing the leaking fluid to occupy that space.

I KNOW THAT THERE ARE NO CONTACT PARTS BUT WHAT ABOUT THE ENERGY LOSS DUE TO INTERNAL FLUID FRICTION? Friction converts to heat. This heat is contained in the motor and forced to work before exiting. Friction heat is simply converted to work. No direct net loss. Walla! It really is this simple.

WHAT TEMPERATURE RANGE CAN A PIM OPERATE IN? The PIM can be configured to operate efficiently at any given temperature range that has molecular movement provided the construction material can remain stable enough at that range to maintain proper tolerances. This means that a PIM can be configured to operate in at temperature range above absolute zero.

WHAT KIND OF FUEL CAN A PIM USE? A PIM is a heat differential engine that can operate in both open-loop and closed-loop. What this means is that a PIM uses a difference in temperature to produce work or work to produce a difference in temperature. In other words a PIM can be configured to work with ALL fuels. In a closed-loop PIM, anything you can use to make one end hotter than the other end, can be used. Here are some examples of external fuel sources for a PIM, the sun, the ground, bodies of water, 99.99% efficient propane burners that can be purchased at any hardware store for a few bucks, a burner fueled by any common fuel such as methanol, gasoline, bio-diesel etc. . . . You could also choose to burn the fuel internally (open-loop). Internal combustion is not recommended except where extreme power/weight ratios are absolutely required such as aeronautic turbine replacement and battery replacement for wearable appliances. By utilizing external combustion or expansion (closed-loop), the release of the energy contained in the fuel can be guaranteed to be at least 99.99% efficient. This is because 99.99% burners and expanders already exist and are commonly available.

WHAT FLUIDS CAN A PIM UTILIZE? A PIM can be configured to work with any matter that can exist in a fluid state. However PIMs require something compressible within the fluid in order to create positive displacement. If there is nothing compressible in the fluid then the pressure is limited to the reactions that can be generated by the moving CVD disks at either end of the motor and the flow is limited to the total leakage through the motor, useless! This is because PIMs rely on the ability to have two or more distinctly different pressure zones exist within a common fluid.

An example of distinctly different pressure zones within a common fluid would be if you place a boat propeller in water and apply sufficient power you can cause an air pocket occur on one side of the propeller and loose traction. These pockets are called cavitations. Cavitations occurs because water (a non-compressible fluid) usually contains air (a compressible fluid) and by applying power to the propeller a difference in pressure occurs between the front and back of the propeller blades thereby allowing the air in the water to expand. On the other hand if the non-compressible fluid (water) contains absolutely no compressible fluid (air) then the entire fluid volume would be at the exact same pressure and no cavitations would occur, unless you add so much power that you cause the water to phase change. In certain PIM applications you can think of the chamber(s) in a PIM as containing a series of cavitations that are traveling from one pressure zone to a different pressure zone.

WHAT RPM OR SPEED RANGE IS THE PIM DESIGNED FOR? The PIM can be configured for any rpm or speed range at which the construction materials can remain stable enough to maintain acceptable tolerances. The PIM does not require high rpm in order to be efficient or produce big power. It makes much more sense to stay at lower speed in order to utilize cheaper materials and manufacturing methods and only use higher speeds where extremely high power to weight ratios are required such as aircraft use and wearable power packs.

WHAT MATERIALS CAN BE USED FOR MAKING A PIM? The PIM can be made from any material that can remain stable enough within the intended rpm and heat of that motor. For example if a PIM is configured to operate from 100 to 200 degrees and 0-2000 rpm it would only require cheaper, softer, lower grade materials like wood, plastic, urethane foam. If a PIM is configured for 1000 to 1500 degrees and 10000 rpm than it requires much harder, stronger, higher grade materials like steel, ceramic, composites.

HOW IS THE PIM MADE? WHAT MANUFACTURING METHODS ARE USED? The PIM is so extremely versatile that it can be made with just about any manufacturing method. The manufacturing method available is the main determining factor for the configuration of the PIM. The PIM can be configured for high quality, high precision manufacturing methods like machining, forging, complex multistage casting and made from high quality, rigid materials like steel, glass, and aluminum. If only low quality, low precision manufacturing methods are available like hand tools, band saw, drill then the PIM can be configured accordingly. The quality of the manufacturing method is the primary factor that determines the power density and versatility of a given PIM. A better, higher quality manufacturing method means a smaller, more powerful, more versatile PIM.

HOW CAN THE PIM WORK WITH NON-COMPRESSIBLE FLUIDS EFFICIENTLY SINCE IT REQUIRES A COMPRESSIBLE IN ORDER TO ACTUALLY CREATE POSITIVE DISPLACEMENT? In order to pump non-compressible fluids effectively with a PIM you have to fool the PIM into thinking its pumping a compressible fluid. This is done in three ways.

The first method is called gas placebo. Gas placebo is simply the addition of a compressible fluid to non-compressible fluid for the purpose of making it behave like a compressible fluid. Gas Placebo is the ideal method for hydroelectric power plant use. A huge proportion of air could be inserted in the water stream at the very top intake (low pressure) side. As the combined air and water stream progresses down it becomes compressed by its on weight and generates heat and pressure. When the stream arrives at the bottom it is hot and infused with highly compressed air. Before entering the PIM the flow is severely constricted. This constriction allows the PIM to harness the expansion of the gas to release the heat energy contain within the fluid stream. This makes a PIM far more effective than a standard water turbine as the PIM does not try to harness the weight of the water drop for a direct reaction like a turbine but in fact harnesses the full heat energy potential of the water drop. The other huge advantage of a PIM over a water turbine is that a PIM can produce useable work from an extremely small water drop therefore allowing for its use in small free flowing rivers without requiring damming or significant interruption of flow.

Second method is called object placebo. Object placebo is a non-permeable but compressible object(s) that is permanently placed inside of a fluid chamber or added to the fluid stream. It is not always possible or practical to add a compressible fluid to a non compressible fluid. When this is the case than a permanent compressible object placebo can be incorporated into each of the fluid chambers or into the fluid stream. This object placebo allows a differential to occur between the inside and outside of the fluid chamber making constant volume displacement possible with a non-compressible fluid. This method is likely to be used for pumping hazardous fluids in closed environments.

Third method is Phase Placebo. Phase placebo is the use of a fluid that phases into or out of a gaseous state during operation. The gas provides a compressible. This method is the most likely method to be used in closed loop PIMs. Phase placebo provides the greatest energy density potential in a closed loop. Closed loop phase placebo PIMs have the highest efficiency and longevity potential, and are therefore the most ideal configuration for PIMs.

ENTROPY MAKES 100% CONVERSION IMPOSSIBLE! Well this statement is both true and untrue. If you take general entropy theory at face value than 100% conversion is impossible with a cyclic process engine. This is because the thermodynamic cycle requires time to occur. This time increases as the system energy increase and therefore entropy increases as system energy increases. This being said, in order to have no entropy in a cyclic process the cyclic process either has to have no time or no energy. If a cyclic process has no energy, it is not a cyclic process. If a cyclic process has no time than it has no energy (only energy potential), and again it is not a cyclic process. Catch 22 maybe even Catch 23. All of these statements are based on the cyclic process in the way that we are accustomed.

WHAT IS THE SUPER DUPER SUPER UPER DUPER CYCLE “SDSUDC”? SDSUDC is best defined as an asymmetric, infinitely daisy chainable, and infinitely reducible, thermodynamic cycle that permanently and inseparably joins two complete thermodynamic loops within one system, and with the potential to be equally efficient for both forward and reverse function.

The PIM relies on a completely new cyclic process that will redefine the way in which we think of engines, pumps, and of energy in general. This new process is called the Super Duper Super Uper Duper Cycle “SDSUDC”. The biggest difference between SDSUDC all other cyclic process is that SDSUDC can have 0% time on three subsystems of a PV loop and 100% time on a single subsystem of a PV loop. It does this by combining the same cycles as a Sterling Cycle, isothermal and isometric. Unlike a Sterling Cycle the SDSUDC uses a process called value locking resulting in forced simultaneous pairing “FSP”, in order to reduce the duration between the isothermal and isometric by creating a relationship that does not change. Since the volume of the chamber is constant, pressure and heat are directly and unvaryingly linked to each other. In a PIM, energy can only affect the pressure in a chamber, not the volume. In contrast, a change in energy in a Sterling Cycle engine affects both the pressure and the volume of a chamber.

The next big difference from a Sterling Cycle and SDSUDC is that SDSUDC is designed for both open and closed loop. SDSUDC cycles can be daisy chained out to infinity, and reversed, and looped back to any point in the daisy chain, all within the same system. In other words in a closed loop PIM when you insert energy into the system it goes through the PIM and whatever is not converted the first time through can be taken back to the origin or to other PIMs for further conversion by a neutral loop called Nyne. A closed loop PIM's exhaust gas becomes its intake gas over and over. The fluid can keep repeating this cycle until the system reaches its minimum operational energy level. There is also the option of adding reversed PIMs to the loop in order to double the work density potential by creating equilibrium between the amount of work being done by fluid expansion and fluid contraction. PIMs can be inserted into most known cyclic process to significantly raise efficiency of those processes.

HOW DOES FORCED SIMULTANEOUS PAIRING “FSP” WORK? In the super duper super uper duper cycle “SDSUDC”, forced simultaneous paring is applied to a pair of isothermal and isometric cycles by limiting the change in volume to specific values (value locking) instead of a range of values, while allowing the change in pressure to maintain a range of values and not specific values. In other words we provide a limited number of specific values (instead of a range of values) for one axis of the PV loop and a range of values (instead of specific values) for the other axis of the PV loop. By limiting the choices on one axis of the PV loop to specific values, the time that would normally be expended traveling the range of values along that axis is shifted to the other axis of the PV loop that has a range of values. The net effect is that we can use value locking to shift the time in a PV loop of a thermodynamic process where it is needed (the work production side). The shifting of non-productive time to productive time results in massive entropy reduction.

WHY DO YOU BELIEVE THAT THE PIM HAS A 99.99+% CONVERSION POTENTIAL? The PIM combines SDSUDC (which can eliminate all of the time not spent working W=˜100%), and stage stacking (which allows you to divide a difference in pressure an infinite number of times ΔP/∞), and then adds displacement stacking (which allows you to divide a volume a nearly infinite number of times limited only by the technology to build smaller machines). The PIM winds up with a thermodynamic cycle that has an energy potential as small as one, a minimum duration potential as short as one, and a minimum volume so small that it may as well be one. It might even have a 100% conversion potential.

In the short term SDSUDC engines can be integrated into all existing major utility systems (electric, water, gas etc. . . . ) to raise those system efficiencies with minimal cost and easy integration. SDSUDC is tied into the waste heat systems and can be integrated without interrupting utilities.

In the long term PIMs are so simple and versatile and inexpensive to manufacture that the economic model for major utilities will change. Future utilities will have extremely low capital investment in disposable, sealed, no maintenance, easily scaleable PIMs instead of massive capital investment in non-scaleable turbine systems. The main focus of electric utilities will become power distribution and not production. This is because as PIMs become more prevalent the majority of power production will actually be done by PIMs located at each individual home/usage site. These PIMs leverage solar heat against cold ground, cold water, cold air, etc. . . .

Best of all since the PIM is not only the most efficient engine ever but also the most efficient compressor ever. The largest single segment responsible for greenhouse gasses which is the production and consumption of electrical power for indoor climate control will be considerably reduced as PIM heat pumps are integrated into more systems.

The PIM will be the predominant heat to work conversion method as long humanity exists. With the PIM there is no need to try to move to the “Hydrogen Economy” as we can go directly to the “Heat Economy”. Hydrogen is simply another totally unnecessary step in an extremely long list of totally unnecessary steps that are added to heat to work conversion. The most efficient way to convert heat to work is simply to convert heat to work. The most efficient iteration of the hydrogen economy would involve converting solar heat to electricity. Then electricity would have to be used for electrolysis to produce hydrogen. Then hydrogen would have to be converted back to electricity through electrolysis. At every chemical conversion there is a loss. PIM technology allows heat to be simply stored as heat by phasing a fluid into a more dense fluid and converted to work or electricity as needed by allowing the fluid to phase back to its original state with no need to chemically convert the heat into any other form. No need to use electrolysis to convert heat into hydrogen. No need to use electrolysis again to convert hydrogen back into electricity. If there is no chemical conversion there is no chemical conversion loss. The PIM utilizes fluid phasing for direct heat to work conversion with no chemical conversion middleman.

PIMs can work on a very small difference in temperature therefore the energy can be stored in the form of a safe phase changing material like brine water ice, or dry ice, or liquid carbon dioxide etc. These materials all phase change below ambient temperature. In these types of applications the hot side of a PIM is ambient air and the cold side is the energy release from the storage media. This is called cold fueling. Temperature differentials of hundreds of degrees are easily possible with low temperature, inert, phase changing materials. These types of materials provide the cheapest, safest, completely pollution free method of storing a large amount of energy in a vehicle, in a plane, or on a person. Very few people would be willing to carry a high pressure, extremely explosive, flammable, hydrogen fuel pack just for the convenience of more power storage than a battery. Most people would be willing to carry an ice cube, or dry ice, or very low pressure non-flammable liquid carbon dioxide (safer than a can of hairspray), in a small container. The use of non-flammable fuels eliminates the possibility of fuel related fires. Inert solids, liquids, and gasses don't catch fire. Imagine the lives saved. PIM technology is so simple that it will provide an unlimited, pollution free, energy conversion method that is accessible to all people regardless of income. Hopefully the availability of unlimited free energy will eventually lead to the elimination of money.

HOW IS IT POSSIBLE TO OPEN AND CLOSE THE VALVES FOR THE CORRECT DURATION AND AT THE CORRECT MOMENT MILLIONS OF TIMES PER SECOND? Here is where the real magic is, and here is where it gets a bit more complicated. First, the valves and the valve ports are one and the same. There is no mechanical valve closing a valve port because the valve IS the valve port. The opening and closing of the valve ports and therefore control of fluid flow is accomplished by moving one chamber and its valve port(s) relative to a different chamber and its valve port(s). In a PIM the exhaust valve port from one pressure zone feeds directly into the intake valve port for the next pressure zone. This eliminates the need to have a separate valve or for that matter any kind of valve train.

Duration and sequence of valve opening is the key to constant volume displacement, and is controlled by group timing system. Group timing system is a method for determining the duration, sequence, and order, of the exhaust valve open duration and the intake valve open duration, and is applied to mechanical components, occurring along two pairs of equal duration planes that can be arranged in any manner that complies with the group timing system, and describes a time relationship that allows the intake valve opening duration and exhaust valve opening duration of one or more chambers and or valve planes to be arranged such, that the intake valve and exhaust valve are never simultaneously open for any chamber in the system. Group timing system is so special because it allows an infinite number of fluid chambers and stages to be linked.

Group timing system is composed of four durations. The first duration is the exhaust duration range. Exhaust duration range is the duration during which an exhaust valve can be open, and is also the maximum possible duration for an exhaust valve to be open, however it does not indicate the actual exhaust valve opening duration. Exhaust valve opening duration is the actual duration that an exhaust valve is open. The reason that the exhaust opening is configured within a range (exhaust duration range) instead of a specific duration and time, is that the exhaust from one stage is the intake for the next stage and therefore the range of occurrence is always directly related to the sum of the exhaust valve opening duration and intake valve opening duration minus the overlap. If the exhaust valve opening duration and the intake valve opening duration are the equal then the exhaust duration range and the intake duration range will then be equal to the actual exhaust valve opening duration and intake valve opening duration.

The second duration is pause one, the duration that separates the exhaust duration range from the intake duration range. Pause one is the duration that corresponds to the portion of a fluid chamber that the fluid flows through. Pause one is critical because it provides the necessary separation between the intake and exhaust strokes of a chamber.

The third duration intake duration range is the duration during which an intake valve can be open, and is also the maximum possible duration for an intake valve to be open, however it does not indicate the actual intake valve opening duration. Intake valve opening duration is the actual duration that an intake valve is open. The reason that the intake opening is configured within a range (intake duration range) instead of a specific duration and time, is that the exhaust from one stage is the intake for the next stage and therefore the range of occurrence is always directly related to the sum of the exhaust valve opening duration and intake valve opening duration minus the overlap. If the exhaust valve opening duration and the intake valve opening duration are the equal then the exhaust duration range and the intake duration range will then be equal to the actual exhaust valve opening duration and intake valve opening duration.

Pause two is the duration that separates the intake duration range from the end of the displacement duration. Pause two is the duration that corresponds to the portion of a fluid chamber that may be used to provide a reservoir which causes an asymmetry between the reaction created by the intake and the reaction created by the exhaust. This asymmetry increases both efficiency and power density. Pause two is critical because it provides the necessary separation between the exhaust stroke of one chamber and the next intake stroke of the subsequent chamber.

Fluid enters a chamber through the intake port. The intake port is always separated from the end of the chamber by pause two. If pause two is used to contain a pocket, the pocket gives fluid the potential to expand to both sides of the port when it enters. Pause two also provides a reservoir. Fluid then flows through pause one which always separates the intake and exhaust ports. The exhaust port is always abuts the end of the chamber and therefore is able to produce higher pressure than the intake because fluid within the chamber can only expand to one side of the exhaust port.

A chamber that has no pocket occurring at pause two then it has a potential zero difference between the reaction of the intake valve and the reaction of the exhaust valve. Therefore if a chamber has no pause two pocket the flow can be reversed at equal efficiency by simply switching the hot and cold inputs. The intake and exhaust valves are distinguishable from each other only as a function of direction of flow. If a chamber has a pause two pocket there is an asymmetry in the reaction between the intake and exhaust valves for that chamber. This means that in order to reverse flow at equal efficiency the sequence of the four displacement duration subsystems must be reversed in order to point the asymmetry in the new direction of flow.

CAN PIMs DO ANYTHING TO REVERSE THE GREENHOUSE EFFECT OR SEQUESTER GREENHOUSE GASES THAT ALREADY EXIST? The answers to those questions are “Yes”, and “Yes’. PIMs through their extreme efficiency and extreme ease and universality of implementation will help to reduce the greenhouse effect drastically and immediately. PIMs also can provide for very large scale use of solar energy to power compressor PIMs that compressed large volumes of ambient air into liquid in order to separate greenhouse gases from other gasses for the purpose of underground sequestration in salt domes or in other geological underground formations. Also linear PIMs might be able to generate escape velocity, in order to launch super massive chunks of frozen greenhouse gasses directly into space.

THE PLANETARY IMPROVEMENT MOTOR SOUNDS TO GOOD TO BE TRUE, CAN YOU PROVE IT? No and yes, somewhat, sort of. No the PIM is not too good to be true. I developed the PIM by building actual, functional physical models which prove that constant volume displacement works, and that it does exist, and that it can divide a difference in pressure as many times as desired just as the third law of thermodynamics mandates it to. So at the very worst the Planetary Improvement Motor is a new, super efficient, and extremely simple, positive displacement pump and engine design that can operate through a broad range of temperatures, and that has only two parts and no physical contact between the two, and with nearly limitless applications. At best it is nearly 100% efficient and will end world hunger and greenhouse gas production. I believe that 99% efficiency is self evident in the physics involved, however I am only just starting to learn about the subject and do not have sufficient knowledge to compose an equation to verify 99% efficiency, yet. As far as Super Duper Super Uper Duper Cycle and all of the other theoretical mumbo jumbo talk they are essentially my uneducated guesses based on observations, as to what I believe are the thermodynamic mechanism underlying the function of PIMs. Since these are based on my hypothesis from an observation it means that I believe that the physics make them self evident. So, I can absolutely prove the function of and existence of constant volume displacement however I cannot yet prove 99% efficiency. The Earth can't wait. Therefore I am willing to risk intellectual embarrassment, based on just the slightest possibility that Planetary Improvement Motors might be able to reduce the destruction of earth, and maybe help us to not extinguishing ourselves.

“HEY POLLUTION AND WORLD HUNGER, IN YOUR FACE!”

1. Heat Economy is an economic concept whereby energy is converted to work and work to energy directly at the point of usage.

2. Cold Fueling is a thermodynamic concept that mandates energy to be stored only in compounds that phase below ambient temperature.

3. Pimgine is a displacement pump that can also be used as a displacement engine, at similar efficiency for both pump and engine usage, without requiring the addition or subtraction of any components, and is a term that is applicable to most Planetary Improvement Motors, however to avoid confusion the term pimgine only appears a few times in this application.

4. Displacement Stacking is to displace fluid more than one time through one chamber during one revolution of a revolving displacement pump or engine, or one linearlution of a linear displacement or lateral displacement pump or engine.

5. Turbulence Induced Sealing is the addition of texture to two or more surfaces moving in close proximity to each other in order to attach fluid to the individual surfaces to reduce both drag and fluid leakage that occurs between the different surfaces, turbulence induced sealing does this pinching vortices of fluid in the boundary layer between the fluid that is attached to the individual surfaces.

6. Super Duper Super Uper Duper Cycle is a cyclic thermodynamic system that may be infinitely daisy chained, and that may be configured for both open loop and closed loop operation, and that may be inserted into most other thermodynamic systems that contains two, individual separate thermodynamic loops, each loop composed of two pairs of isothermal and isometric cycles.

7. Value Locking is method of shifting the allocation of time within a thermodynamic loop by limiting the values for either the pressure component or the volume component to specific values, and allowing the remaining component to have a range of unspecific values.

8. Forced Simultaneous Subsystem Pairing is when the two individual pairs of thermodynamic cycles that compose one loop such as isothermal and isometric, are forced into having a direct, mutually dependant, unvarying, relationship with each other thereby reducing the duration for each pair of cycles to the minimum level possible.

9. Forced Loop Pairing occurs when one displacement of fluid through one chamber of a displacement pump or engine is forced into containing two complete thermodynamic loops in series.

10. Stage stacking is the containment of more than one stage of a multistage displacement engine in a manner such that the leakage from one stage (that is normally wasted) is contained and goes directly to the next stage in series with no net loss of energy.

11. Nyne is a neutral thermodynamic subsystem that is added to a thermodynamic system by providing a passage that allows fluid to flow between the highest pressure zone and the lowest pressure zone of a system, closing the loop in order to continue adding or subtracting energy from the fluid.

12. Constant Volume Displacement “CVD” is form of cyclic positive displacement that displaces a fluid from one pressure zone to a different pressure zone by containing fluid within a fixed volume chamber that has at least one intake port and one exhaust port, then adding or subtracting energy to or from the fluid, the resulting change in energy within the chamber displaces fluid into or out from the chamber and produces work from both the displacement of fluid into the chamber and the displacement of fluid out of the chamber.

13. Group timing system is a system that describes abstract time relationships that create constant volume displacement and is used to determine the duration and sequence of valve opening and closing along four equal duration abstract planes with one pair of planes being used to contain a chamber, and the second pair of planes being used to contain the first pair of planes, and describes a time relationship that allows the intake valve opening duration and the exhaust valve opening duration, of one to infinity chamber(s) and or valve planes and or stages, to be arranged such that the intake valve and exhaust valve for any chamber are never simultaneously open.
Elements or steps 13.1 Create four equal duration planes then applying the group timing equations, placing an exhaust on the first plane, an intake on the second plane, an exhaust on the third plane, and an intake on the fourth plane, then line up the center of the exhaust duration range of the first plane with the center of the intake duration range of the fourth plane to get zero group offset. After the timing is determined, an infinite number of four plane groups can be multiplied and connected to each other without the intake and exhaust valves for any chamber ever being simultaneously open. These durations can then be applied to any shape or form of mechanical system as long as the durations and sequence are not altered.
13.1.1 Group Duration is the total duration for one revolution or linearlution of one pressure zone contained by a pump or engine.
13.2 Displacement Duration is derived by taking the group duration and dividing it by the number of chambers in the group, and is the total duration for one displacement of fluid through one chamber, and is composed of four durations that always occur in the following reversible sequence 1=Exhaust duration range 2=Pause one 3=Intake duration range 4=Pause two.
13.2.1 Exhaust Duration Range is the duration during which an exhaust valve can be open, and is also the maximum possible duration for an exhaust valve to be open, however it does not indicate the actual exhaust valve opening duration.
13.2.1.1 Exhaust Valve Opening Duration is the actual duration that an exhaust valve is open.
13.2.2 Pause One is the duration that separates the exhaust duration range from the intake duration range.
13.2.3 Intake Duration Range is the duration during which an intake valve can be open, and is also the maximum possible duration for an intake valve to be open, however it does not indicate the actual intake valve opening duration.
13.2.3.1 Intake Valve Opening Duration is the actual duration that an intake valve is open.
13.2.4 Pause Two is the duration that separates the intake duration range from the end of the displacement duration.
13.2.5 Displacement Duration Offset is the difference in time between the start of the second plane and the third plane that are used to contain the chamber.
13.2.6 Group Offset is the difference in time between the midpoint of the exhaust valve duration range of the first plane and the midpoint of the intake duration range of the fourth plane and is used to compensate for the displacement duration offset by making it equal to the displacement duration offset.
13.2.7 Linearlution is a term for both a linear displacement pump or engine and a lateral displacement pump or engine, analogous to the duration of one revolution in a revolving engine, defined as a total duration starting at the beginning of the first displacement duration and ending at the end of the last displacement duration.
13.2.8 Group Timing equations are defined relative to displacement duration with the following equations.
X=Group Duration X/Y=A
Y=Total displacements per group Y·A=X
A=Displacement Duration A
B=Valve Opening Duration Range B≦0.5A
C=Total Pause Duration C+B=A C=A−B
D=Exhaust Duration Range D+C+F=A D=0.5B
Dₐ=Exhaust Valve Open Duration Dₐ≦D
E=Pause One E+B+G=A E≧0.5B
F=Intake Duration Range F+C+D=A F=0.5B
Fₐ=Intake Valve Open Duration Fₐ≦F
G=Pause Two G+B+E=A G≧0.5B

14. CVD Chamber System is a system that describes a group of physical components and various arrangements to which the group timing system can be applied, that may be used to build a constant volume displacement engine or pump.
Elements or steps 14.1 Distinct Displacement Chamber “DDC” is a chamber within a fluid, capable of containing some of the fluid at a different pressure, for a sufficient duration to generate useable work.
14.1.1 DDC Side Walls are the walls of a DDC that are used to connect two or more CVD disk valves.
14.1.2 DDC end walls are DDC side walls that are closest to the beginning of occurrence and the end of occurrence of a DDC, and that separate one DDC from the next occurring DDC.
14.1.3 DDC Exhaust Valve Port is the opening through which fluid exits one pressure zone to a different pressure zone.
14.1.4 DDC Intake Valve Port is the opening through which fluid enters one pressure zone from a different pressure zone.
14.1.5 Pause One Pocket is the physical space in a DDC that corresponds to the duration separating the DDC intake port and the DDC exhaust port.
14.1.6 Pause Two Pocket is the physical space in a DDC that corresponds to the duration between the DDC exhaust port and the end of the DDC.
14.2 CVD Disks contain one or more distinct displacement chambers and or one or more CVD disk valve(s) within a common pressure zone, CVD disks are used to change the energy of fluid by displacing fluid between stationary CVD disk(s) and a moving CVD disk(s), in other words work is produced by pushing and pulling moving CVD disks and using fixed CVD disks as an anchor from which to push and pull the moving CVD disks.
14.2.1 CVD Disk Valve is a physical object that occurs along one plane and which is used to separate two or more pressure zones, and which has one or more openings that permit fluid to move from one pressure zone to another pressure zone.
14.2.1.1 CVD Intake Valve is a CVD disk valve that contains one or more intake valve port(s).
14.2.1.1.1 CVD Intake Valve Port is the opening(s) that permits fluid to enter a pressure zone.
14.2.1.2 CVD Exhaust Valve is a CVD disk valve that contains one or more exhaust valve port(s).
14.2.2.2.1 CVD Exhaust Valve Port is the opening(s) that permits fluid to exit a pressure zone.
14.3 CVD Disk Core is a structure to which moving CVD disk(s), CVD disk valve(s), are attached.
14.4 CVD Disk Housing is a structure to which stationary CVD disk(s) or CVD disk valve(s) are attached.
14.5 CVD Transfer Cap is a cap that may be used to stop or limit fluid flow at one or both ends of a CVD disk housing or CVD disk core, and which may also be used to transfer heat energy into or out from the contained fluid.
14.6 Housing Coupler is a coupler that can effectively contain a transfer of fluid between two or more CVD disk housings.
14.7 Core Coupler is a coupler that can effectively contain a transfer of fluid between two or more CVD disk cores.
14.8 Energy Tank is a portable energy storage tank for CVD pumps and engines.
14.9 Flow Limiter is a device that limits the flow of fluid through a CVD pump or engine in order to increase the difference in pressure between two or more pressure zones affecting the pump or engine, and is analogous to an orifice tube or expansion valve in an air conditioner.
14.10 Transfer Bars are electrically conductive objects that are used to join two or more magnetic fields, for the purpose of transferring electrical energy into or out of a CVD engine or pump.
14.11 Transfer Fluid is the primary fluid displaced that is used to transfer energy between stationary and moving CVD disks.
14.12 Generator Bearing Magnets are magnets that can be located on both moving, and fixed components, and that can be used to transfer electrical energy into or out from a CVD engine or pump, and that also may be used as a bearing.
14.13 Mass Displacement is the mass of a displaced volume.
14.14 Displacement Styles are methods of arranging the location and motion of DDCs, CVD disks, and transfer fluid.
14.14.1 Circular Displacement is a physical method of arranging chambers for the purpose of creating circular motion by moving fluid through pressure zones that are arrange laterally from the direction of motion, and where the pressure zones are arranged in an alternating fashion such that the fluid flows between moving and stationary chambers.
14.14.2 Lateral Displacement is a physical method of arranging chambers for the purpose of creating linear motion by moving fluid through pressure zones that are arrange laterally from the direction of motion, and where the pressure zones are arranged in an alternating fashion such that the fluid flows between moving and stationary chambers.
14.14.3 Linear Displacement is a physical method of arranging chambers for the purpose of creating linear motion by moving fluid through pressure zones that are arranged along the axis of motion, and where the pressure zones are arranged in an alternating fashion such that the fluid flows between moving and stationary chambers.
14.15 Ratio method describes ways to create a difference in mass displacement between two or more CVD disks and is somewhat analogous to the compression ratio of a piston engine except that ratio method is not a direct measure of a change in volume like compression ratio but is instead defined by the potential difference in the amount of mass that two or more planes can displace.
14.15.1 Reaction Inequity is present in all multistage PIMs, and is the difference in mass displacement of two or more stages.
14.15.2 Disk Stacking alters mass displacement by varying the thickness and therefore the volume of a CVD disk.
14.15.3 Disk Coning alters mass displacement by varying the diameter and therefore the volume of a CVD disk.
14.15.4 DDC Skipping alters mass displacement by skipping one or more DDCs, or in some other way not utilizing all of the available volume within a CVD disk.
14.15.5 Time shifting alters mass displacement by varying the distribution of the four individual durations that compose DDC duration, while still complying with Group Timing System.
14.15.6 Geometry alteration alters mass displacement by varying the shape of components and the reaction that they generate.

15. Differential Seeding is addition of a compressible object(s) to a non-compressible fluid in order to create multiple pressure zones within a common fluid to facilitate constant volume displacement with a non-compressible fluid, and is accomplished.
15.1 Gas Placebo is the addition of a compressible fluid to a dissimilar fluid.
15.2 Object Placebo is the temporary or permanent addition of one or more compressible object(s) to a fluid.
15.3 Phase Placebo is the phasing of a fluid into or out of a gaseous state.
